(19) United States
(12) Patent Application Publication
(10) Pub. No.: US 2023/0189041 A1
(43) Pub. Date: Jun. 15, 2023

(54) ENHANCED RADIO RESOURCE MANAGEMENT (RRM) MEASUREMENT GAP PROCEDURE

(71) Applicant: QUALCOMM Incorporated, San Deigo, CA (US)

(72) Inventors: Hyun Yong LEE, San Diego, CA (US); Prashanth Haridas HANDE, San Diego, CA (US); Peerapol TINNAKORNSRISUPHAP, San Diego, CA (US); Ravi AGARWAL, San Diego, CA (US); Mickael MONDET, Louannec (FR); Arvind Vardarajan SANTHANAM, San Diego, CA (US); Ozcan OZTURK, San Diego, CA (US); Yuchul KIM, San Diego, CA (US); Linhai HE, San Diego, CA (US); Huilin XU, Temecula, CA (US)

(21) Appl. No.: 18/073,412

(22) Filed: Dec. 1, 2022

Related U.S. Application Data
(60) Provisional application No. 63/287,963, filed on Dec. 9, 2021.

(51) Int. Cl. H04W 24/10; H04W 28/02; H04W 76/28

(52) U.S. Cl. CPC H04W 24/10; H04W 28/0268; H04W 76/28

(57) ABSTRACT

Certain aspects of the present disclosure provide techniques for an enhanced measurement gap procedure. For example, according to one aspect, a method for wireless communications by a user equipment (UE) generally includes receiving signaling, from a network entity, configuring the UE to prioritize data traffic processing over at least one measurement procedure and processing data traffic to or from the network entity in accordance with the signaling.

### CROSS REFERENCE TO RELATED APPLICATIONS

This application claims benefits of and priority to U.S. Provisional Pat. Application No. 63/287,963, filed on Dec. 9, 2021, which is assigned to the assignee hereof and herein incorporated by reference in the entirety as if fully set forth below and for all applicable purposes.

### INTRODUCTION

Aspects of the present disclosure relate to wireless communications, and more particularly, to techniques for an enhanced measurement gap procedure by selectively prioritizing data traffic or a measurement procedure in measurement gaps.

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available system resources with those users (e.g., bandwidth, transmit power, or other resources). Multiple-access technologies can rely on any of code division, time division, frequency division orthogonal frequency division, single-carrier frequency division, or time division synchronous code division, to name a few. These and other multiple access technologies have been adopted in various telecommunication standards to provide a common protocol that enables different wireless devices to communicate on a municipal, national, regional, and even global level.

Although wireless communication systems have made great technological advancements over many years, challenges still exist. For example, complex and dynamic environments can still attenuate or block signals between wireless transmitters and wireless receivers, undermining various established wireless channel measuring and reporting mechanisms, which are used to manage and optimize the use of finite wireless channel resources. Consequently, there exists a need for further improvements in wireless communications systems to overcome various challenges.

### SUMMARY

One aspect of the present disclosure provides a method for wireless communications by a user equipment (UE). The method generally includes receiving signaling, from a network entity, configuring the UE to prioritize data traffic processing over at least one measurement procedure and processing data traffic to or from the network entity in accordance with the signaling.

One aspect of the present disclosure provides a method for wireless communications by a network entity. The method generally includes transmitting, to a user equipment (UE), signaling configuring the UE to prioritize data traffic processing over at least one measurement procedure and processing data traffic to or from the UE in accordance with the signaling.

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

The appended figures depict certain features of the various aspects described herein and are not to be considered limiting of the scope of this disclosure.

FIG. 1 is a block diagram conceptually illustrating an example wireless communication network.

FIG. 2 is a block diagram conceptually illustrating aspects of an example of a base station and user equipment.

FIGS. 3A, 3B, 3C, and 3D depict various example aspects of data structures for a wireless communication network.

FIG. 4 depicts an example extended reality (XR) scenario in which aspects of the present disclosure may be practiced.

FIG. 5A and FIG. 5B depict example connected-mode discontinuous reception (CDRX) timelines.

FIG. 6 depicts an example of the potential impact of CDRX cycles on burst traffic processing.

FIG. 7A and FIG. 7B depict example measurement gap configurations.

FIG. 8 depicts an example of the potential impact of measurement gaps on burst traffic processing.

FIG. 9 and FIG. 10 depict examples of the potential impact of measurement gaps and CDRX cycles on burst traffic processing.

FIG. 11 is a call-flow diagram for an example enhanced measurement gap procedure, in accordance with certain aspects of the present disclosure.

FIG. 12, FIG. 13, FIG. 14, FIG. 15, and FIG. 16 depict timelines for example enhanced measurement gap procedures, in accordance with certain aspects of the present disclosure.

FIG. 17 illustrates a set of assumptions for simulating the effect of measurement gaps on burst traffic processing, in accordance with certain aspects of the present disclosure.

FIG. 18A, and FIG. 18B illustrate simulation results depicting the success rate of measurement gaps relative to packet delay budget (PDB) performance for burst traffic, in accordance with certain aspects of the present disclosure.

FIG. 19A, FIG. 19B, FIG. 19C, and FIG. 19D illustrate simulation results depicting the impact of measurement gaps on burst traffic processing, in accordance with certain aspects of the present disclosure.

FIG. 20A, FIG. 20B, FIG. 20C, and FIG. 20D illustrate simulation results depicting the impact of measurement gaps on burst traffic processing, in accordance with certain aspects of the present disclosure.

FIG. 21 is a flow diagram illustrating example operations for wireless communication by a network entity, in accordance with certain aspects of the present disclosure.

FIG. 22 is a flow diagram illustrating example operations for wireless communication by a UE, in accordance with certain aspects of the present disclosure.

FIG. 23 depicts aspects of an example communications device.

FIG. 24 depicts aspects of an example communications device.

### DETAILED DESCRIPTION

Aspects of the present disclosure provide apparatuses, methods, processing systems, and computer-readable mediums for an enhanced measurement gap procedure by selectively prioritizing data traffic or a measurement procedure in measurement gaps.

5G new radio (NR) provides a high-speed, low-latency and high-reliability wireless connectivity which can enable a wide variety of applications, including immersive extended reality (XR) multimedia and cloud computing services. These advanced multimedia applications may require high data rate and low latency to help traffic meet its packet delay budget (PDB), which generally refers to an upper bound for the delay of the data packets transferred by a bearer. Advanced multimedia applications may also require better power saving functionality to improve XR device performance. To reduce power consumption, a user equipment (UE) may be configured for discontinuous reception (DRX) operation.

In 5G NR systems, a UE operating in multi-frequency cellular networks is typically configured with measurement gaps, in which the UE intermittently suspends data transmission to measure neighboring cells. A measurement gap is typically given automatic priority over data traffic because it functions to seek out better wireless signaling in a multi-frequency cellular network. As a result, a measurement gap may interrupt the transmission of bursty data traffic, which may impact the ability to meet PDB requirements.

According to certain aspects of the present disclosure, a UE may implement an enhanced measurement feature to address the traffic delays in data transmission caused by measurement gap prioritization. According this enhanced measurement feature, data traffic processing (e.g., reception/transmissions) may be prioritized over cell measurement in certain cases. In some cases, the enhanced measurement feature may be configured to operate in combination with DRX operations. By selectively prioritizing data traffic processing, the impact of measurement gaps on PDB requirements may be mitigated. In some cases, a UE may be dynamically reconfigured to prioritize the measurement procedure over data traffic processing, in some measurement gaps, which may provide the flexibility to still take measurements (e.g., inter-cell or cross-link interference-CLI) in certain scenarios, while still improving overall PDB performance.

### Introduction to Wireless Communication Networks

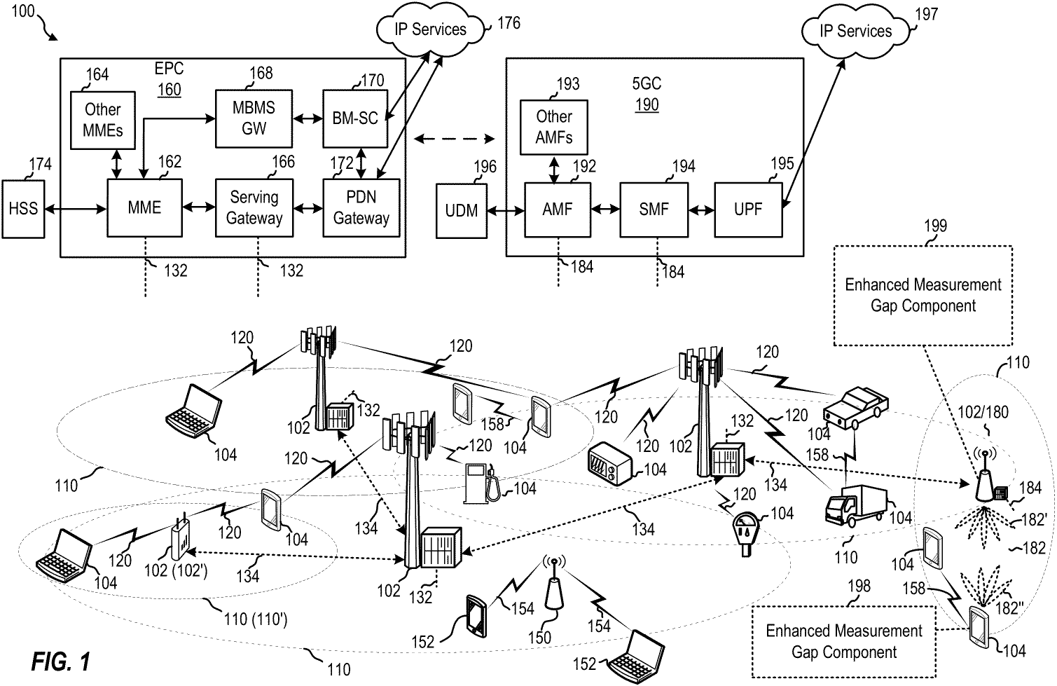

FIG. 1 depicts an example of a wireless communications system 100, in which aspects described herein may be implemented.

Generally, wireless communications system 100 includes base stations (BSs) 102, user equipments (UEs) 104, one or more core networks, such as an Evolved Packet Core (EPC) 160 and 5G Core (5GC) network 190, which interoperate to provide wireless communications services.

Base stations 102 may provide an access point to the EPC 160 and/or 5GC 190 for a user equipment 104, and may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, delivery of warning messages, among other functions. Base stations may include and/or be referred to as a gNB, NodeB, eNB, ng-eNB (e.g., an eNB that has been enhanced to provide connection to both EPC 160 and 5GC 190), an access point, a base transceiver station, a radio base station, a radio transceiver, or a transceiver function, or a transmission reception point in various contexts.

Base stations 102 wirelessly communicate with UEs 104 via communications links 120. Each of base stations 102 may provide communication coverage for a respective geographic coverage area 110, which may overlap in some cases. For example, small cell 102′ (e.g., a low-power base station) may have a coverage area 110′ that overlaps the coverage area 110 of one or more macrocells (e.g., high-power base stations).

The communication links 120 between base stations 102 and UEs 104 may include uplink (UL) (also referred to as reverse link) transmissions from a user equipment 104 to a base station 102 and/or downlink (DL) (also referred to as forward link) transmissions from a base station 102 to a user equipment 104. The communication links 120 may use multiple-input and multiple-output (MIMO) antenna technology, including spatial multiplexing, beamforming, and/or transmit diversity in various aspects.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player, a camera, a game console, a tablet, a smart device, a wearable device, a vehicle, an electric meter, a gas pump, a large or small kitchen appliance, a healthcare device, an implant, a sensor/actuator, a display, or other similar devices. Some of UEs 104 may be internet of things (IoT) devices (e.g., parking meter, gas pump, toaster, vehicles, heart monitor, or other IoT devices), always on (AON) devices, or edge processing devices. UEs 104 may also be referred to more generally as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, or a client.

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, base station 180 and the UE 104 may each include a plurality of antennas, such as antenna elements, antenna panels, and/or antenna arrays to facilitate the beamforming.

In some cases, base station 180 may transmit a beamformed signal to UE 104 in one or more transmit directions 182′. UE 104 may receive the beamformed signal from the base station 180 in one or more receive directions 182″. UE 104 may also transmit a beamformed signal to the base station 180 in one or more transmit directions 182″. Base station 180 may also receive the beamformed signal from UE 104 in one or more receive directions 182′. Base station 180 and UE 104 may then perform beam training to determine the best receive and transmit directions for each of base station 180 and UE 104. Notably, the transmit and receive directions for base station 180 may or may not be the same. Similarly, the transmit and receive directions for UE 104 may or may not be the same.

Wireless communication network 100 includes enhanced measurement gap component 199, which may be configured to prioritize data traffic processing over a measurement gap procedure. Wireless network 100 further includes enhanced measurement gap component 198, which may be used configured to prioritize data traffic processing over a measurement gap procedure.

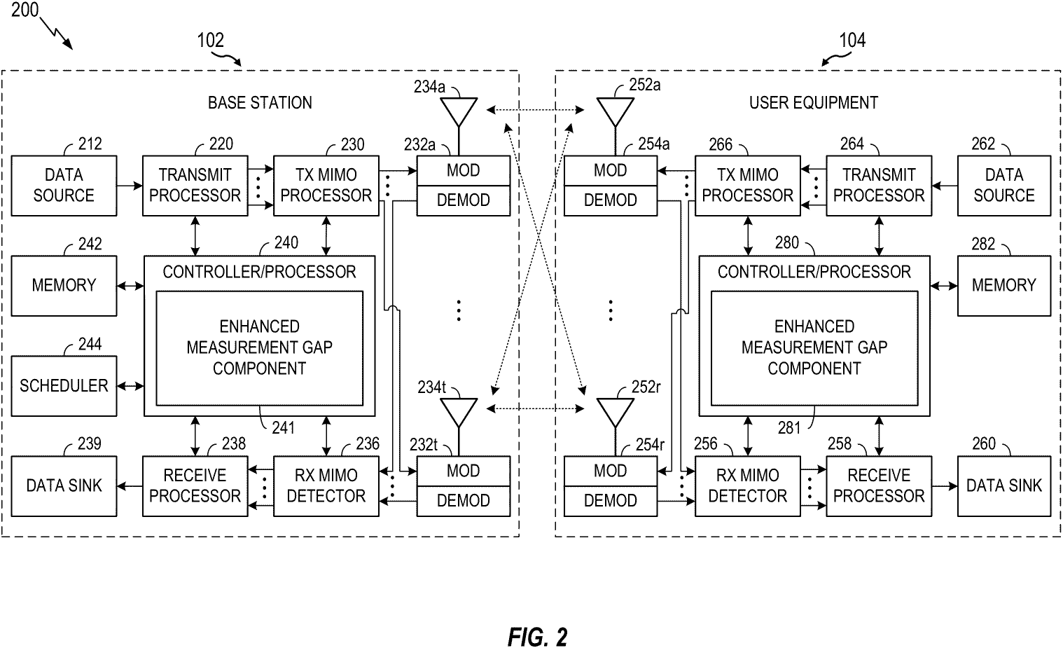

FIG. 2 depicts aspects of an example base station (BS) 102 and a user equipment (UE) 104.

Generally, base station 102 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, base station 102 may send and receive data between itself and user equipment 104.

Base station 102 includes controller / processor 240, which may be configured to implement various functions related to wireless communications. In the depicted example, controller / processor 240 includes enhanced measurement gap component 241, which may be representative of enhanced measurement gap component 199 of FIG. 1. Notably, while depicted as an aspect of controller / processor 240, enhanced measurement gap component 241 may be implemented additionally or alternatively in various other aspects of base station 102 in other implementations.

Generally, user equipment 104 includes various processors (e.g., 258, 264, 266, and 280), antennas 252a-r (collectively 252), transceivers 254a-r (collectively 254), which include modulators and demodulators, and other aspects, which enable wireless transmission of data (e.g., data source 262) and wireless reception of data (e.g., data sink 260).

User equipment 104 includes controller / processor 280, which may be configured to implement various functions related to wireless communications. In the depicted example, controller / processor 280 includes enhanced measurement gap component 281, which may be representative of enhanced measurement gap component 198 of FIG. 1. Notably, while depicted as an aspect of controller / processor 280, enhanced measurement gap component 281 may be implemented additionally or alternatively in various other aspects of user equipment 104 in other implementations.

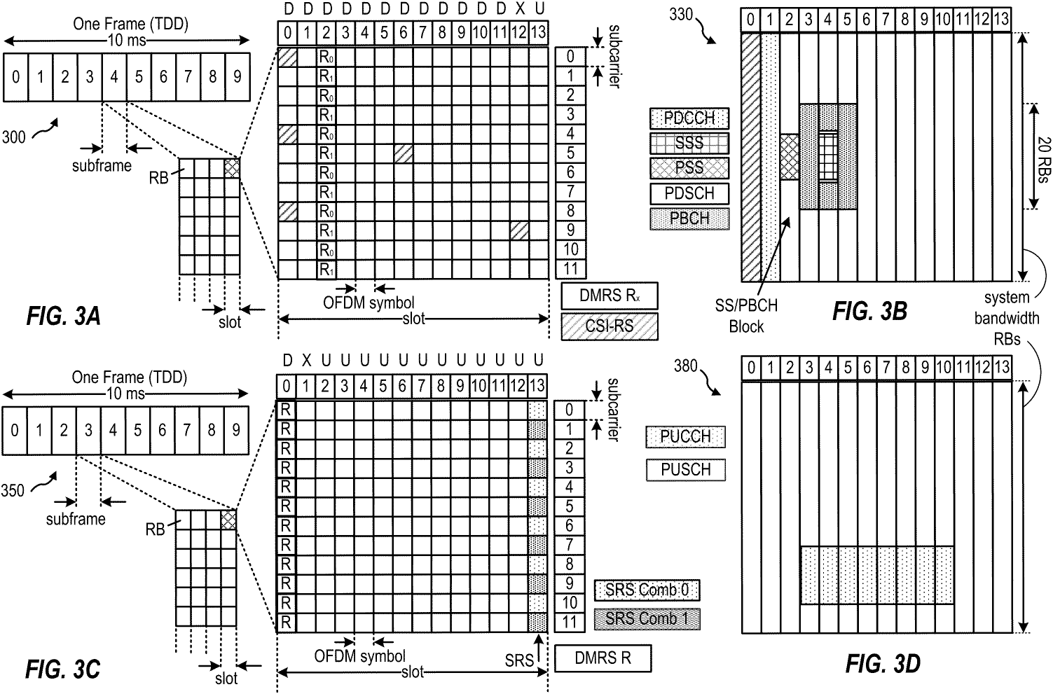

FIGS. 3A-3D depict aspects of data structures for a wireless communication network, such as wireless communication network 100 of FIG. 1. In particular, FIG. 3A is a diagram 300 illustrating an example of a first subframe within a 5G (e.g., 5G NR) frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL channels within a 5G subframe.

Further discussions regarding FIG. 1, FIG. 2, and FIGS. 3A-3D are provided later in this disclosure.

### Introduction to mmWave Wireless Communications

In wireless communications, an electromagnetic spectrum is often subdivided into various classes, bands, channels, or other features. The subdivision is often provided based on wavelength and frequency, where frequency may also be referred to as a carrier, a subcarrier, a frequency channel, a tone, or a subband.

5G networks may utilize several frequency ranges, which in some cases are defined by a standard, such as the 3GPP standards. For example, 3GPP technical standard TS 38.101 currently defines Frequency Range 1 (FR1) as including 600 MHz - 6 GHz, though specific uplink and downlink allocations may fall outside of this general range. Thus, FR1 is often referred to (interchangeably) as a “Sub-6 GHz” band.

Similarly, TS 38.101 currently defines Frequency Range 2 (FR2) as including 26 - 41 GHz, though again specific uplink and downlink allocations may fall outside of this general range. FR2, is sometimes referred to (interchangeably) as a “millimeter wave” (“mmW” or “mmWave”) band, despite being different from the extremely high frequency (EHF) band (30 GHz - 300 GHz) that is identified by the International Telecommunications Union (ITU) as a “millimeter wave” band because wavelengths at these frequencies are between 1 millimeter and 10 millimeters.

Communications using mmWave / near mmWave radio frequency band (e.g., 3 GHz - 300 GHz) may have higher path loss and a shorter range compared to lower frequency communications. As described above with respect to FIG. 1, a base station (e.g., 180) configured to communicate using mmWave / near mmWave radio frequency bands may utilize beamforming (e.g., 182) with a UE (e.g., 104) to improve path loss and range.

### Overview of Discontinuous Reception for Extended Reality

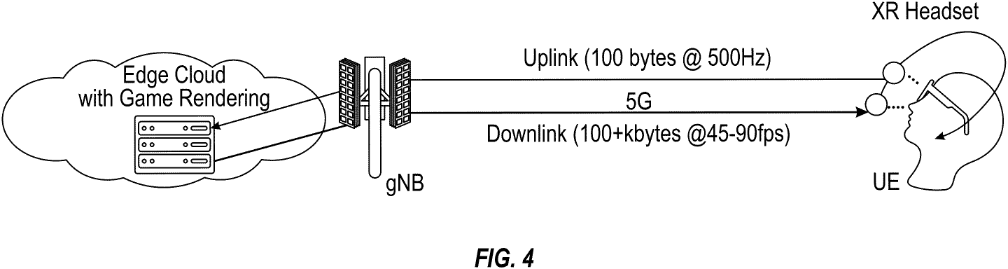

5G new radio (NR) provides a high-speed, low-latency and high-reliability wireless connectivity which can enable immersive virtual reality (VR), augmented reality (AR) and extended reality (XR) multimedia and cloud computing services. XR/multimedia data service communications are illustrated in FIG. 4 and may include various user interface (UI) devices, such as AR Glasses and VR Head-Mounted Displays (HMDs) used in Cloud-based Gaming and Cloud-based artificial intelligence (AI). These advanced multimedia applications may have strict system requirements. Requirements include high data rate and low latency to better allow a targeted 99% of XR traffic to be delivered within a packet delay budget (PDB) (e.g., 10 ms), and low power consumption to better save power on multimedia devices.

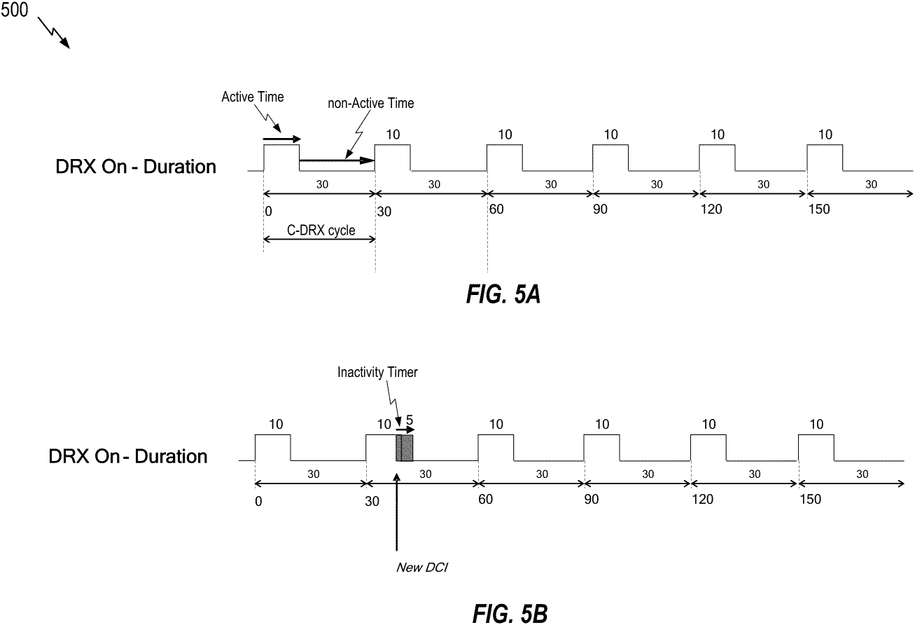

To reduce power consumption, a user equipment (UE) may be configured for discontinuous reception (DRX) operations. As illustrated in FIG. 5A, during a connected DRX mode (CDRX), UE duration can be broadly divided into “Active time” and “non-Active” times.

During a CDRX Active time (or On-Duration), the UE monitors for physical downlink shared channel (PDSCH) activity with a given periodicity or continuous monitoring, receives downlink data, transmits UL data, and/or makes serving cell or neighbor measurements. During Active time, a UE is generally considered “on” while various timers are running. For example, an Active duration timer (e.g., drx-onDurationTimer), an inactivity timer (drx-InactivityTimer), and a complete DRX cycle duration (e.g., drx-ShortCycle) may run during an Active time. The beginning of a DRX cycle may be defined by a starting offset value. In FIGS. 5A & 5B, the Active time is 10 ms and the CDRX cycle duration is 30 ms. In FIG. 5B, a UE is configured with an inactivity timer that restarts when activity is detected and expires after 5 ms without detected activity. When the inactivity timer expires, the UE enters an “inactive” or “sleep” mode.

In some cases, a UE may be configured with an enhanced CDRX (eCDRX) mode to mitigate drift in latency resulting from misalignment with traffic burst arrivals. Current CDRX mode is configured for integer value periodicity, while typical multimedia data traffic update rates (e.g., 60 Hz, 90 Hz, 45 Hz, 120 Hz, or 48hz) often lead to non-integer value periodicity.

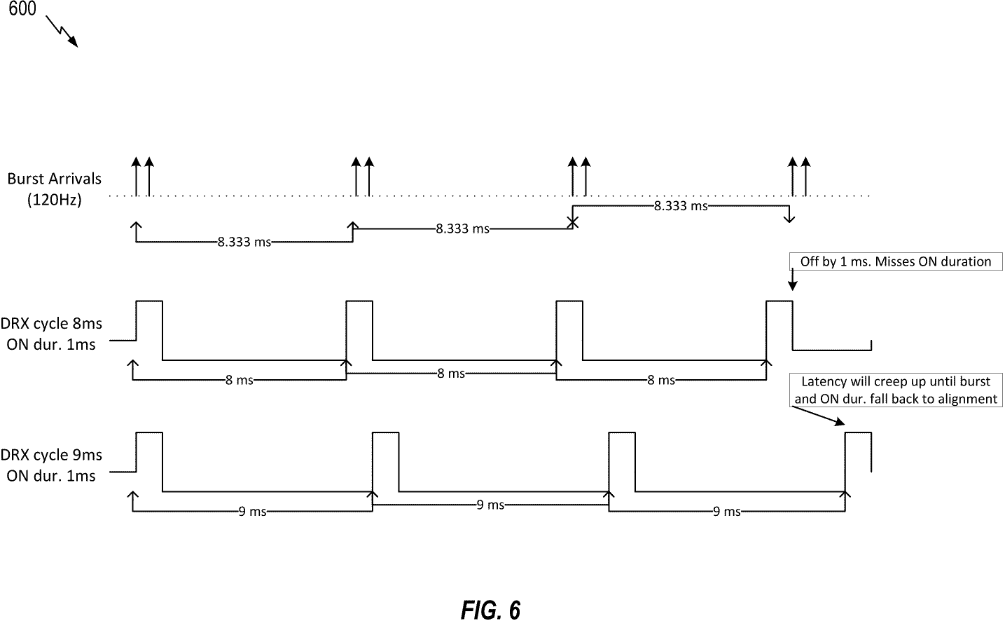

FIG. 6 illustrates an example of drift resulting from misalignment between typical multimedia data 120 Hz Burst Arrivals (e.g., at the gNB) having a 8.33 ms periodicity and CDRX cycles having 8 ms and 9 ms periodicities. eCDRX may support non-uniform DRX cycles, however (e.g., 8 ms-8 ms-9 ms cycling) may might help adjust align DRX cycles with multimedia cadence (and mitigate the impact of drift).

### Overview of Measurement Gaps

As noted above, in current systems (e.g., 5G NR systems), a UE intermittently suspends data transmission to measure neighboring cells by implementing a measurement gap feature. A measurement gap generally refers to a duration of time where a UE performs certain measurement procedures.

For example, for an inter-cell measurement procedure, the UE may measure neighboring cells in a multi-cellular network during measurement gaps. In such cases, the UE should measure the neighboring cells and other carrier components using different frequencies. However, many UEs may include a single radio frequency (RF) module to reduce the manufacturing cost and form factor size. As a result, such UEs are unable to perform the inter-frequency measurement while maintaining the data traffic with serving cell.

Various scenarios may be addressed using measurement gaps. For example, measurement gaps may be used for inter-frequency handover (within a same radio access technology/RAT), as well as for inter-RAT handover. In such cases, a UE may measure a target frequency to perform the inter-frequency or inter-RAT handover. During the measurement gap, a UE may temporarily suspend its communication with the serving cell, and measure the inter-frequency. In some cases, measurement gaps may be used in certain operating frequency ranges (e.g., FR2) for a UE to perform a receive (Rx) beam search for intra-frequency handover. In such cases, an FR2 UE Rx beam may be directed towards the serving cell and, during the measurement gap, the UE can temporarily suspend its communication with the serving cell, and redirect its Rx beam towards a target cell. In some cases, a UE configured with an active bandwidth part (BWP) without intra-frequency SSBs may use measurement gaps to temporarily tune its transceiver to a different BWP to receive the intra-frequency SSB.

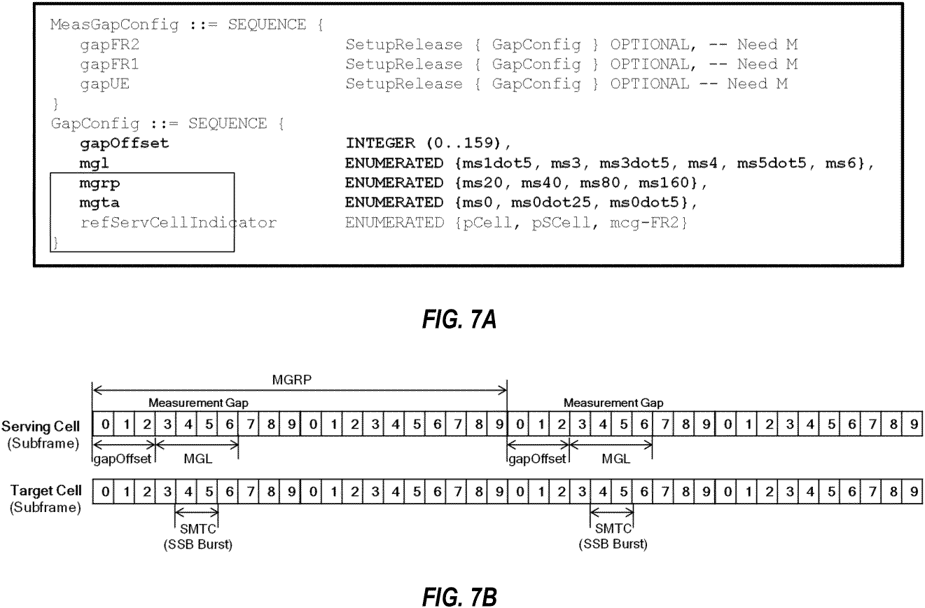

As illustrated in FIG. 7A and FIG. 7B, measurement gaps are typically configured with an offset (e.g., gapOffset), length (e.g., mgl), repetition period (e.g., mgrp), and timing advance (e.g., mgta). The measurement gap may be designed to include a target cell synchronization signal block (SSB) measurement timing configuration (SMTC) as illustrated in FIG. 7B. As such, the measurement gap repetition periodicity must be a multiple of SSB burst periodicity. In the illustrated example, the UE is configured with a 20 ms measurement gap periodicity, 4 ms measurement gap length, which is sufficient to cover a 2 ms target cell SMTC.

In current systems, a measurement gap is typically given automatic priority over data traffic. In such systems, measurement gaps may be given a higher priority than physical downlink shared channel (PDSCH) or physical uplink shared channel (PUSCH) transmissions, except during an initial attach procedure (e.g., for Msg2/Msg3/Msg4 in a 4-step RACH procedure and/or MsgA/MsgB in a 2-step RACH procedure) because it functions to seek out better wireless signaling in a multi-frequency cellular network.

As a result, when a measurement gap is configured, maximum UE peak throughput may be reduced according to the measurement gap length. Because of this, in some cases, measurement gaps may only be configured when channel quality of a primary cell becomes less than a certain threshold.

### Aspects Related to Enhanced Measurement Gaps

As noted above, configured measurement gaps can interrupt the processing (reception and/or transmission) of bursty data traffic. This may be problematic for certain types of traffic, such as multimedia data traffic, that is expected to be delivered within a certain PDB (e.g., 10 ms).

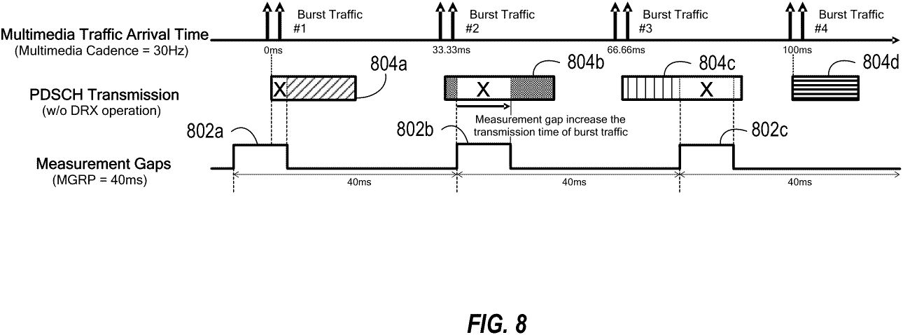

This issue is illustrated in FIG. 8, which shows the potential impact when measurement gaps are placed within the transmission periods for burst traffic. As noted above, it may not be possible to align the measurement gap periodicity (e.g., 20/40/80/160ms) with the periodicity of multimedia traffic or eCDRX periods. Thus, the conflict between overlapping measurement gaps and multimedia traffic transmission cannot be avoided by simply adjusting the offset values due to drift. Because the measurement gap has a higher priority than the normal data traffic in current systems, the UE may be unable to receive any traffic data (e.g., PDSCH) from the gNB during the measurement gap and its preparation time. Thus, the measurement gap increases the transmission time for burst traffic, making it difficult to meet the PDB requirements of multimedia traffic.

In the illustrated example, burst traffic (e.g., multimedia burst traffic #1-#4) arrives at a network entity (e.g., gNB) at a 30 Hz cadence (every 33.33 ms). The burst traffic is delivered to a UE in PDSCH transmissions 804. In the illustrated example, measurement gaps 802 are configured to occur periodically (i.e., every 40 ms) and overlap with the PDSCH transmissions 804, resulting in an increase in transmission time of some of the burst traffic.

For example, measurement gap 802a overlaps with PDSCH transmission 804a used to transmit a first traffic burst, Burst Traffic #1. The overlap is indicated by the “X” and causes a delay in the start of the transmission of the burst traffic until after the end of the measurement gap 802a. Similarly, measurement gap 802b overlaps with a PDSCH transmission period 804b, while measurement gap 802c overlaps with a PDSCH transmission period 804c, causing an increase in transmission time of Burst Traffic #2 and #3. On the other hand, because PDSCH transmission period 804d does not overlap with any measurement gap, it may have a shorter duration and delivery of burst traffic #4 may be more likely to stay within its PDB.

Delivery of multimedia delay traffic may be further delayed when a UE is configured for both a measurement gap feature and eCDRX operation. This is because the inactivity timer (e.g., depicted in FIG. 5B) may expire during the measurement gap, which may cause the UE to enter the inactive state ( “sleep” mode) for the remainder of the eCDRX cycle. The remaining data burst of traffic may be delayed until the start of the next eCDRX cycle, which may cause the PDB requirements of the multimedia traffic to not be met.

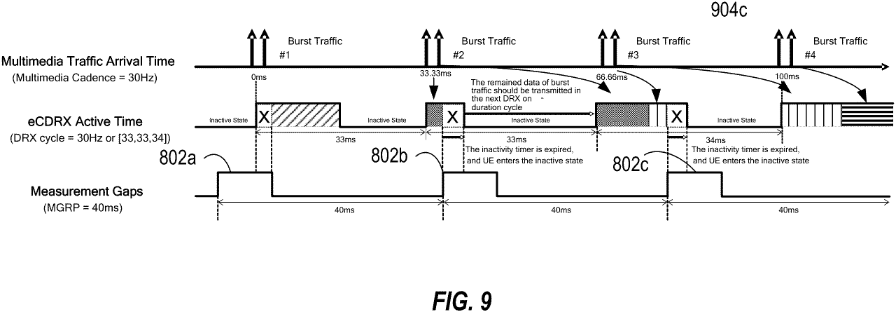

This scenario is illustrated in FIG. 9, where traffic bursts (burst traffic #1-#4) are delivered to a UE in PDSCH transmission periods 804 only during eCDRX Active times. In the illustrated example, measurement gap 802b overlaps with an eCDRX active time in which a PDSCH is sent carrying a portion of Burst Traffic #2. During the measurement gap 802b, the inactivity timer expires and the UE enters the inactive state at the end of the measurement gap 802b. Thus, transmission of a remaining portion of Burst Traffic #2 is delayed until a subsequent on duration (eCDRX Active time). Similarly, measurement gap 802c overlaps with that subsequent on duration, causing the UE to enter the inactive state after transmitting only a portion of Burst Traffic #3 and to delay transmission of a remainder of Burst Traffic #3 until a subsequent on duration. While this subsequent on duration does not overlap any measurement gap, transmission of the remainder of Burst Traffic #3 still delays delivery of Burst Traffic #4. In this example, the PDB requirements for Burst Traffic #2, Burst Traffic #3 and, perhaps, Burst Traffic #4 may not be met.

To avoid the UE entering the sloop mode after a measurement gap, the drx-InactivityTimer could be set higher (e.g., to greater than the measurement gap length MGL + preparation time). Unfortunately, this could_significantly increase the overall power consumption, causing the UE to stay in an active mode unnecessarily in many cases.

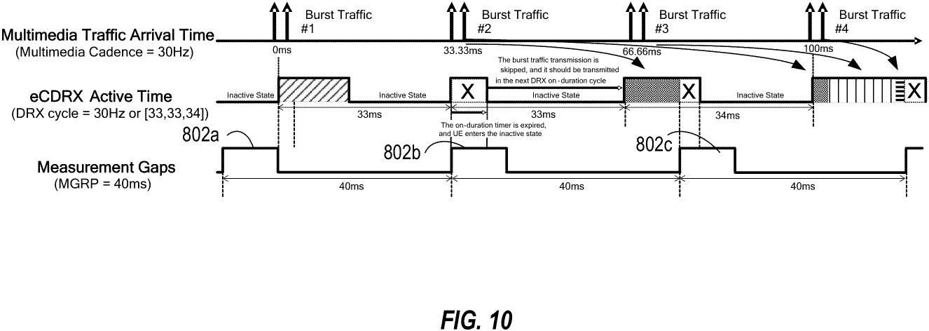

As illustrated in FIG. 10, delays may also be caused when the eCDRX Active (on) duration timer expires during the measurement gap (e.g., before the inactivity timer even starts). In the illustrated example, the on-duration timer expires during the measurement gap 802b. As a result, Burst Traffic #2 is skipped and transmitted in the next DRX on duration. Unfortunately, only a portion of Burst Traffic #2 is transmitted in this next DRX on duration, due to an overlap with measurement gap 802c. Thus, transmission of a remaining portion of Burst Traffic #2 is further delayed until yet another on Duration. As illustrated, this also causes a delay in transmission of Burst Traffic #3 and Burst Traffic #4.

According to certain aspects of the present disclosure, a UE may implement an enhanced measurement feature to address the traffic delays in data transmission caused by measurement gap prioritization. According this enhanced measurement feature, data traffic processing (e.g., reception/transmissions) may be prioritized over cell measurement in certain cases.

As will be described in greater detail below, in some cases, the enhanced measurement feature may be configured to operate in combination with DRX operations. By selectively prioritizing data traffic processing, the impact of measurement gaps on PDB requirements may be mitigated. In some cases, a UE may be dynamically reconfigured to prioritize the measurement procedure over data traffic processing, in some measurement gaps, which may provide the flexibility to still take measurements (e.g., inter-cell or cross-link interference-CLI) in certain scenarios, while still improving overall PDB performance.

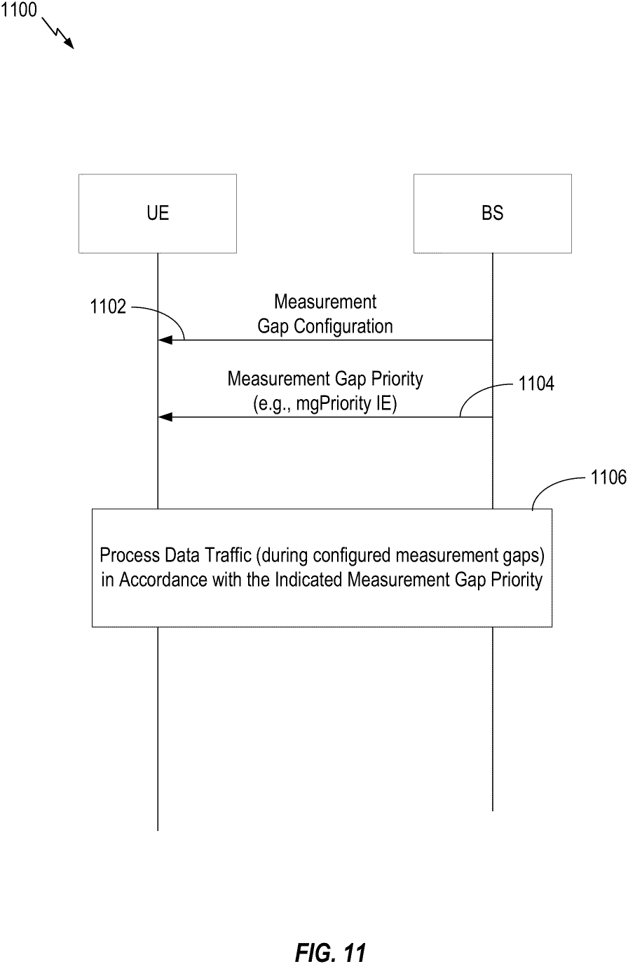

FIG. 11 is a call flow diagram that illustrates how a UE may be configured for an enhanced measurement gap procedure, according to aspects of the present disclosure. As illustrated, at 1102, the UE may receive a measurement gap configuration from a BS (e.g., a gNB). In some cases, this may be a conventional measurement gap configuration (e.g., as described above with reference to FIGS. 7A and 7B).

At 1104, the UE receives an indication of a measurement gap priority, indicating whether the UE is to prioritize data traffic over a measurement gap procedure. At 1106, the UE and BS process data traffic (during configured measurement gaps) in accordance with the indicated measurement gap priority. In some cases, the indication may be provided via an RRC information element (IE), mgPriority, which can configure the priority between the normal data traffic and the measurement gaps (per measGapConfig or measObject). This mgPriority IE may indicate whether the UE is to prioritize data traffic over a measurement gap procedure (e.g., if mgPriority=1) or to prioritize the measurement gap procedure over data traffic (e.g., if mgPriority=0). In other words, if the mgPriority IE is set, the data traffic (PDSCH/PUSCH) of eCDRX active cycle may have a higher priority than the measurement gaps, and the UE is able to keep receiving data packets from (or transmitting data packets to) the gNB.

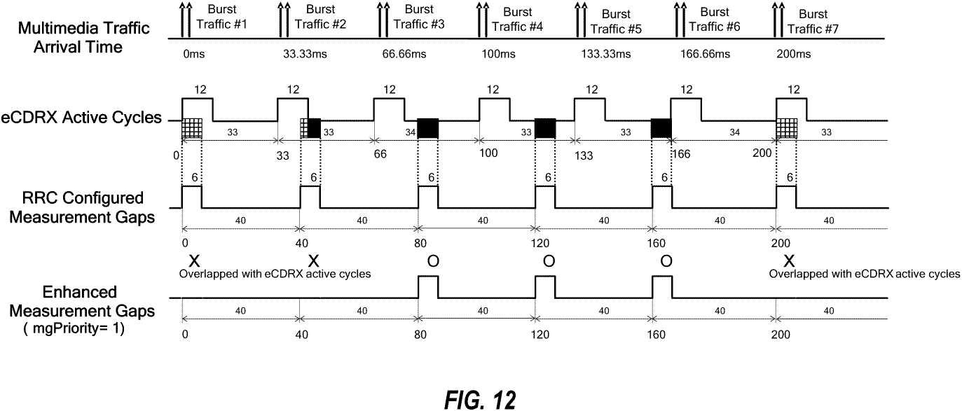

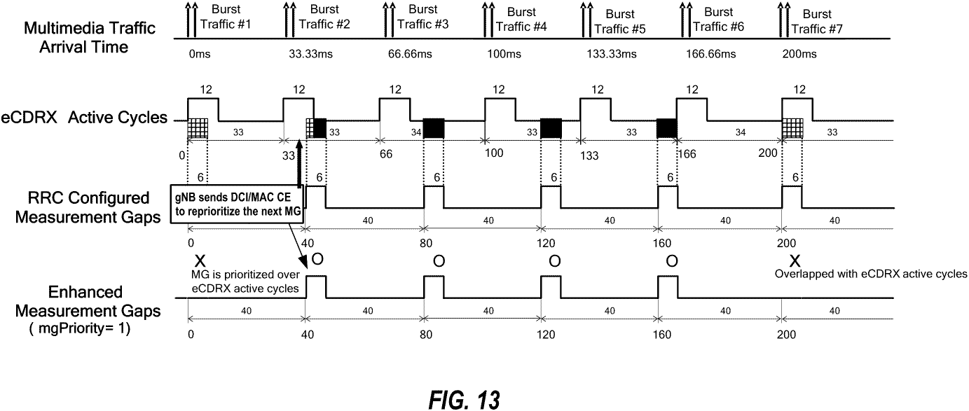

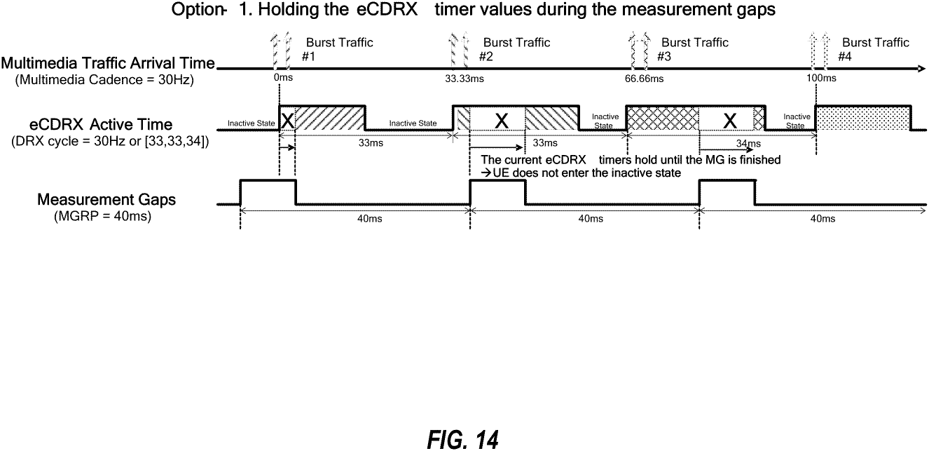

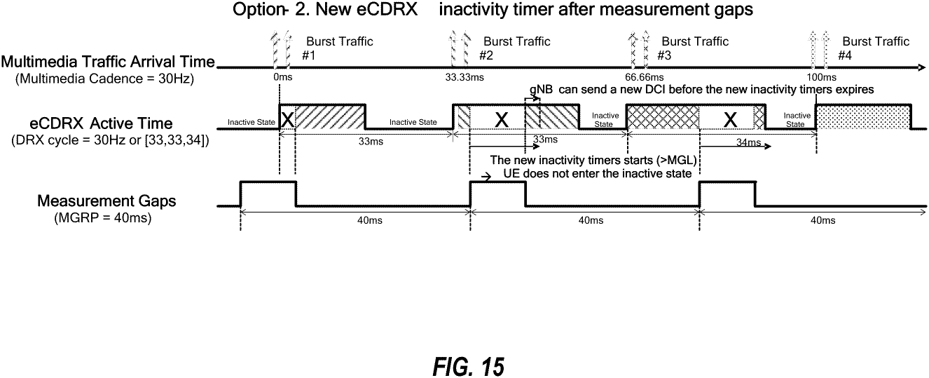

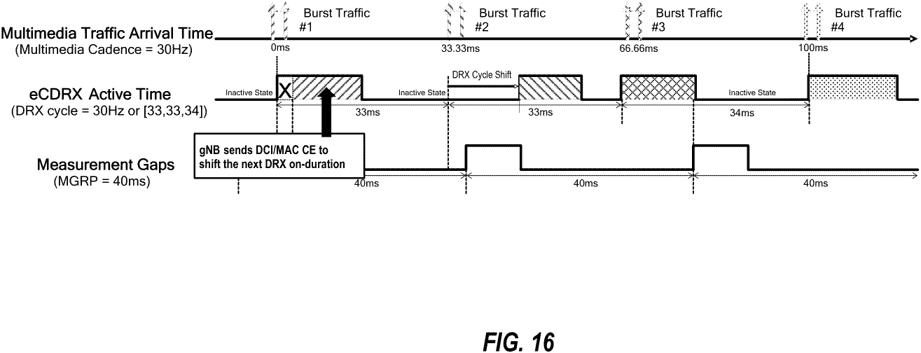

How data traffic may be processed in accordance with the indicated measurement gap priority on FIG. 12 illustrates may be understood with reference to the example timing diagram 1200 of FIG. 12. As illustrated, with mgPriority set (mgPriority=1), RRC configured measurement gaps that overlap with eCDRX active cycles are essentially ignored and data traffic is prioritized over the measurement gap procedure.

For example, because the first two and the last RRC configured measurement gaps overlap with eCDRX active cycles associated with burst traffic #1, #2, and #7, these measurement gaps may be ignored, avoiding the corresponding delays in delivery time of this traffic.

Because the third, fourth, and fifth RRC configured measurement gaps do not overlap with eCDRX active cycles (i.e., they occur in eCDRX inactive cycles), the UE may perform the measurement gap procedure in these measurement gaps without impact on burst traffic delivery.

In some cases, the UE performs the measurement gap procedure only if measurement gap period fits within eCDRX inactive cycles. In such cases, when the UE enters the inactive state, the next DRX on-duration may be placed after the measurement gap period. Otherwise, if a measurement gap period does not fit within an eCDRX inactive cycle, the UE may skip the measurement gap procedure. In such cases, the UE may keep performing PDCCH monitoring and data reception or transmission. In case the UE skips a measurement gap period, the gNB and UE assume that the measurement results remains same as before.

In some cases, the gNB may determine the priority of a measurement gap based on a 5G Quality of Service (QoS) Identifier (5QI) value, which may be indicated from the core network (CN). In such cases, related information may be defined in a 5QI characteristics mapping table.

In some cases, the gNB may set a lowest value of a measurement gap repetition period as an SSB MTC (e.g., 20 ms). This may allow the UE to measure the channel conditions occasionally, for example, according to idle gaps occurring between the burst traffic.

In some cases, even if the normal data traffic is set to a higher priority than the measurement gap, some critical procedures, such as mobility triggered measurement could override the priority. In some cases, a measurement gap may be re-prioritized, for example, by indicating the UE should prioritize a measurement gap procedure over data traffic even if the measurement gap overlaps with an eCDRX on cycle. For example, the UE may be signaled to re-prioritize based on a command conveyed via downlink control information (DCI) or a MAC CE Command for RRM Measurement Gap Re-prioritizing.

Re-prioritizing a measurement gap may be useful in certain scenarios. For example, with the enhanced measurement gap procedure described herein, certain traffic (such as XR traffic) can have a higher priority than the measurement gap, and data traffic reception/transmission can be guaranteed without the interruption of measurement gaps. However, performing the measurement gap procedure at least occasionally could be very important in some conditions, so it may be beneficial to allow the priority of measurement gaps to be controlled, for example, by gNB side. One example condition is if a UE is in a very poor RF condition. If the UE is not able to search the inter-frequency neighbor cells in time, this may cause a radio link failure (RLF) in the 5G link.

Therefore, aspects of the present disclosure provide additional techniques in which a gNB can control the UE to conduct the measurement gap procedure occasionally. For example, according to one option, a new DCI or MAC CE may be used to restore the (higher) priority of measurement gaps.

For example, as illustrated in FIG. 13, during an active eCDRX cycle, the gNB may send the new DCI or MAC CE command to the UE. Thus, even though the mgPriority IE was previously set (mgPriority=1), the high priority of the measurement over data traffic may be restored for the next measurement gap. In some cases, the command may signal a one-time high-priority restoration, to be applied only for the next measurement gap. Thus, as illustrated in FIG. 13, the last measurement gap that overlaps with the eCDRX cycle may be ignored. In this manner, the UE may be forced to conduct the next measurement gap procedure. This approach may allow the gNB with some flexibility on timing of when to send this command to UE.

According to a second option, the gNB may send a command (e.g., a DRX command MAC CE) for the UE to enter the inactive state before the measurement gap. Being in the inactive state may allow the UE to conduct the measurement gap procedure even if the mgPriority IE is set). In some cases, a MAC CE command may be used (or reused) for this purpose, but the gNB may need to meet relatively strict timing to send the DRX command MAC CE to the UE (in order to perform the measurement gap procedure within the inactive state). In some cases, a physical layer (PHY or L1) based signal may be used to command the UE to enter the inactive state to perform a measurement gap procedure.

According to a third option, a special form of DCI may be used for gap re-prioritizing. For example, a DCI with a cyclic redundancy check (CRC) scrambled by a power saving radio network temporary identifier (PS-RNTI), which may be referred to as a DCP, may be used to dynamically re-prioritize one or more measurement gaps. For example, a DCP may be used to notify one or more UEs of a bit map that indicates activation or deactivation of measurement gaps. In this manner, the gNB may use a DCP with such a bit map tore-prioritize one or more subsequent measurement gaps.

In some cases, in case a measurement gap is placed during the transmission time of burst traffic and results in only a portion of burst traffic being transmitted, the remaining data of that burst traffic may be transmitted in the next active (DRX on-duration) cycle. In some cases, to help meet the PDB requirements of multimedia traffic (e.g., 10 ms), the UE may be configured to resume the active state after the measurement gap

As illustrated in FIG. 14, according to one option, the UE may hold (maintain the same values of) the eCDRX timer values during the measurement gaps. In some cases, a new IE may be introduced which enables the UE to hold the values of DRX timers during the measurement gaps. In such cases, the UE may keep the current values of DRX timers such as drx-onDurationTimer, drx-InactivityTimer, and drx-RetransmissionTimer during the measurement gap and resume the timers thereafter.

In the example illustrated in FIG. 14, by holding the eCDRX timers, when traffic delivery for burst traffic #2 and burst traffic #3 is interrupted due to the second and third configured measurement gaps, the UE does not enter the inactive state after the measurement gaps and is able to send the remaining traffic for these bursts. While this effectively shortens the duration of the subsequent inactivity states, any additional power consumption may be worth it in order to meet PDB requirements.

As illustrated in FIG. 15, according to another option, the UE may use a new eCDRX inactivity timer after measurement gaps. In this case, a new IE may be introduced that enables UE to start a new DRX timer (e.g., drx-mginactivity Timer) which starts at the beginning of the measurement gap. If this IE is set, the new DRX timer may start only if the UE has the active state at the beginning of the measurement gap or the next DRX on duration starts within the measurement gap period.

As shown in the example illustrated in FIG. 15, the gNB may set the value of the drx-MgInactivityTimer to be more than the measurement gap length (MGL) in order to provide some remaining inactivity timer after the measurement gap. In other words, as illustrated, the UE may (resume and) stay in the active state while this additional DRX timer is running, thus allowing the gNB to send a new DCI before the new inactivity timer expires.

According to a third option, the UE may take action to go to the active state in order to process (or continue processing) burst traffic. For example, the UE may send a scheduling request (SR) to the gNB to transition to the active state and receive remaining burst traffic data, if the UE had entered the inactive state during a measurement gap. While an SR often indicates the UE has data, in this cases, the UE may send an SR regardless of the actual uplink buffer size. In some cases, the UE could send dummy data in a granted PUSCH, in the case it does not have an actual uplink data. This option may provide some control to the UE, but may take more time when compared to the previous options, which could present a challenge to meeting PDB requirements. This is because the sequence would involve sending an SR, receiving a grant, sending a buffer status report (BSR), starting DRX retransmission timers, and then transitioning to the active state. An SR resource may need to be made (frequently) available to support this approach.

In some cases, the DRX start offset may be shifted, for example, via a DCI or MAC CE. The gNB may utilize this mechanism to adjust dynamic DRX start offset to accommodate the measurement gap operation. Shifting the DRX start offset may allow the measurement gap procedure to occur (e.g., with the benefit up updated measurements) without having to entirely skip a DRX on cycle and wait for the next DRX on cycle (as illustrated in FIG. 9).

For example, as illustrated in FIG. 16, to further improve the success rate of a measurement gap procedure when a measurement gap overlaps with the DRX on cycle after a portion of Burst Traffic #2 is sent, the gNB can shift (fine-tuning) the DRX offset after the measurement gap so that the DRX inactive cycle can cover the entire measurement gap. As a result, rather than waiting for a subsequent active cycle (as in the example of FIG. 9), the UE may receive Burst Traffic #2 (sooner) in the shifted active cycle. As also illustrated, this may allow more (or all) of Burst Traffic #3 to be sent in the subsequent active cycle, since that active cycle does not need to be used for (a remainder of) Burst Traffic #2.

As illustrated in FIG. 16, the gNB may shift the start of the next active state (DRX on duration by a duration labeled DRX Cycle Shift) by sending the DCI/MAC-CE in a previous active state. This may prevent the UE from entering the inactive state during the burst traffic transmission, as the gNB can shift the DRX offset after the measurement gap or shift the DRX offset earlier if the burst traffic packet has arrived earlier.

As noted above, measurement gaps are typically statically configured via RRC signaling. Aspects of the present disclosure, however, may allow for semi-persistent or aperiodic measurement gaps.

For example, in some cases, a gNB may use a MAC-CE to semi-persistently indicate the timing of a measurement gap procedure. In some cases, the gNB may dynamically toggle (activate/deactivate) the measurement gap, for example, according to the channel conditions experienced by the UE (e.g., as reported by the UE via CSI reporting).

In some cases, a gNB may use a DCI MAC-CE to aperiodically indicate the timing of a measurement gap procedure. In some cases, the gNB may configure the UE with periodic timing of a measurement gap using RRC signaling. In such cases, the gNB may then activate the measurement gap, via DCI or MAC CE, when appropriate (e.g., based on channel conditions).

In other cases, the gNB may send a MAC CE command indicating a specific timing of a next measurement gap. In such cases, the (MAC CE) command may include a system frame number (SFN) number, subframe number, and slot offset for the next measurement gap.

In some cases, the network may trigger CLI measurement and reporting from a UE to learn of inter-UE interference (e.g., when dynamic TDD with reconfigurable slots is configured). Applying the various enhancements options described herein may allow for selective prioritization of processing data traffic over CLI measurement (or vice-versa) during CLI measurement occasions (an example of a measurement gap).

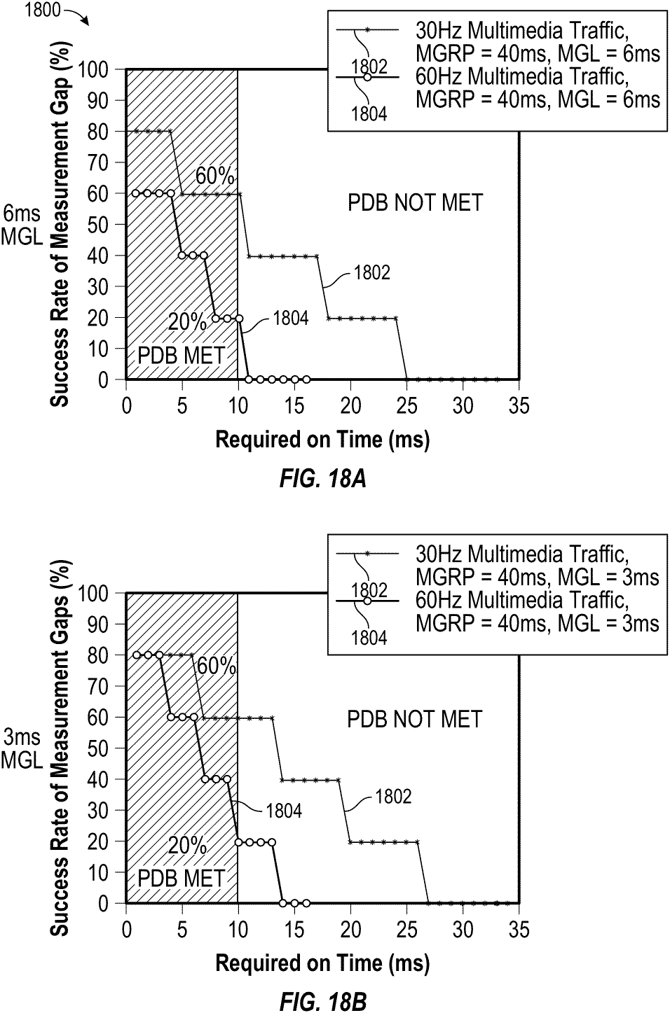

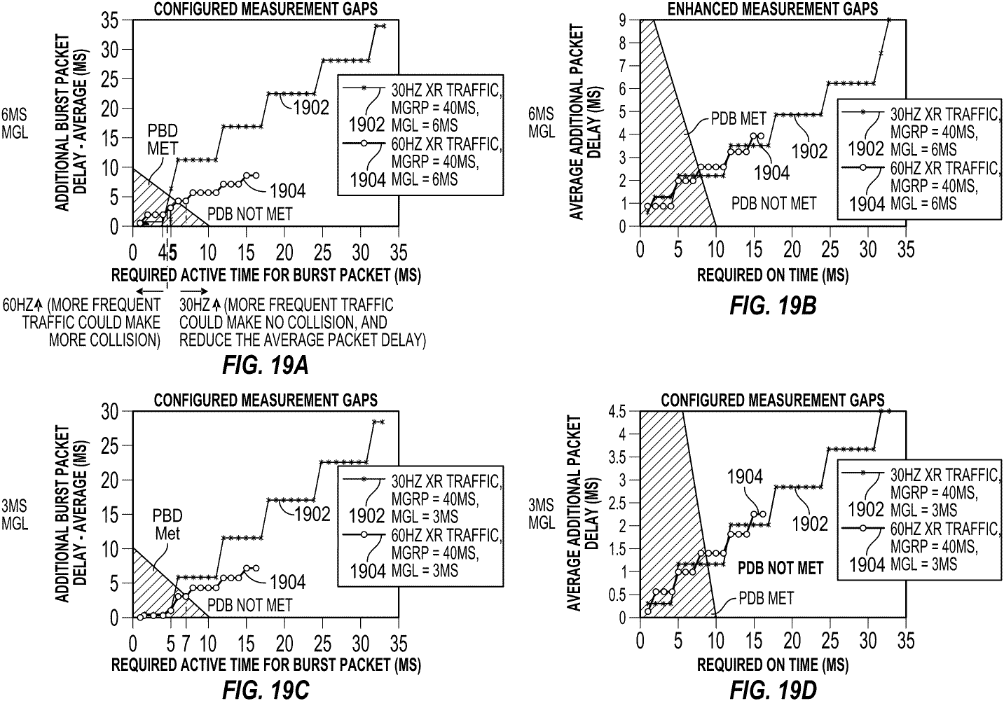

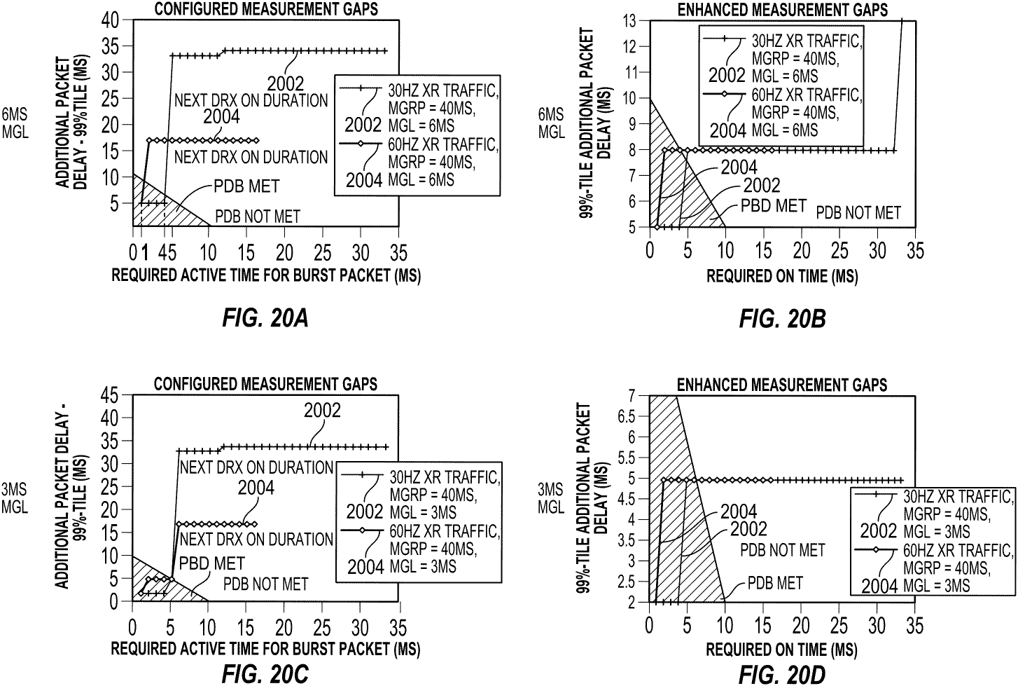

The impact of the enhanced measurement gap procedures described herein may be demonstrated via simulations, the results of which are shown in FIGS. 18A-B, FIGS. 19A-D, and FIGS. 20A-D. The simulations may be based on various assumptions regarding operating conditions, preparation time to enter a measurement gap, and the like.

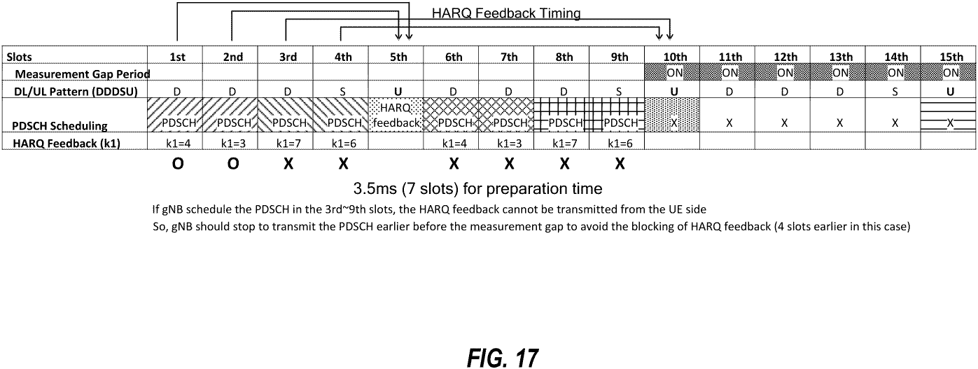

For example, referring to FIG. 17, the simulations may assume that the gNB should complete all the data transmission including HARQ ACK/NACK feedback before the measurement gap starts. The simulations may also assume a 2 ms (4 slot) preparation time, in average, ahead of the measurement gap. In the example illustrated in FIG. 17, the gNB stops the traffic transmission 3.5 ms earlier (e.g., beginning at slot 3) for preparation time before the beginning of the measurement gap (which begins at slot 10 in the example). This is because, in this example, if the gNB were to schedule PDSCH in slots 3-9, the HARQ feedback could not be transmitted from the UE.

FIGS. 18A and 18B are simulation results depicting how the enhanced measurement gap procedures described herein may allow for some percentage of successful measurement gaps (e.g., measurement gaps in which the UE performs measurements on the vertical axis), while still meeting PDB requirements for multimedia traffic. The simulations assume that data traffic has a higher priority than the measurement gaps and varies (sweeps) the required on-time duration for the multimedia traffic (horizontal axis). Both simulations also assume a measurement gap repetition period (MGRP) of 40 ms, a gap offset of 39 ms, on duration timer of 5 ms, and inactivity timer of 2 ms.

For the simulation shown in FIG. 18A, a measurement gap length (MGL) of 6 ms is assumed. For the simulation shown in FIG. 18B, a measurement gap length (MGL) of 3 ms is assumed. In both cases, for multimedia traffic sent at a cadence of 30 Hz (1802), a measurement gap of 60% may be achieved while meeting a packet delay budget of 10 ms (or near) for single and multi-UE scenarios. For multimedia traffic sent at a cadence of 60 Hz (1804), a measurement gap of 40% may be achieved for a single-UE scenario, while a measurement gap of 20% may be achieved for a multi-UE scenario. In both cases, the success rates could be further improved if measurement gap reconfiguration, described above, is implemented (to reprioritize measurement gaps over data traffic).

For the simulation shown in FIG. 18B, a measurement gap length (MGL) of 3 ms is assumed. In this case, for multimedia traffic sent at a cadence of 30 Hz (1802), a measurement gap of 60% may be achieved while meeting a packet delay budget of 10 ms (or near) for single and multi-UE scenarios. For multimedia traffic sent at a cadence of 60 Hz (1804), a measurement gap of 40% may be achieved for a single-UE scenario, while a measurement gap of 20% may be achieved for a multi-UE scenario.

FIGS. 19A and 19B are simulation results depicting average additional burst packet delay resulting from measurement gaps with respect to the necessary duration PDSCH transmission period for burst traffic, assuming a measurement gap length (MGL) of 6 ms, without and with enhanced measurement gaps, respectively.

As illustrated in FIG. 19A, without enhanced measurement gaps, PDB requirements may rarely be met when the required active time is greater than 4 ms, due to significant average additional packet burst packet delay resulting from measurement gaps. For example, for a single-UE scenario, the average additional burst packet delay may be 11 ms for 30 Hz traffic (1902) and 4 ms for 60 Hz traffic (1904). For a multi-UE scenario, the average additional burst packet delay may be 17 ms for 30 Hz traffic and 7 ms for 60 Hz traffic.

As illustrated in FIG. 19B, enhanced measurement gaps may significantly decrease the additional packet burst packet delay resulting from measurement gaps. For example, for a single-UE scenario, the average additional burst packet delay may be 2.2 ms for 30 Hz traffic (1902) and 2 ms for 60 Hz traffic (1904). For a multi-UE scenario, the average additional burst packet delay may be 3.5 ms for 30 Hz traffic and 3.3 ms for 60 Hz traffic, thus allowing PDB requirements to be met more often.

FIGS. 19C and 19D are simulation results depicting average additional burst packet delay resulting from measurement gaps with respect to the necessary duration PDSCH transmission period for burst traffic, assuming a measurement gap length (MGL) of 3 ms, without and with enhanced measurement gaps, respectively. As illustrated, enhanced measurement gaps may bring the average additional packet burst delay down. For example, for a single-UE scenario, the average additional burst packet delay may be lowered from 6 ms for 30 Hz traffic (1902) and 1 ms for 60 Hz traffic (1904) to 1.2 ms and 1 ms, respectively. For a multi-UE scenario, the average additional burst packet delay may be lowered from 12 ms for 30 Hz traffic and 6 ms for 60 Hz traffic to 2 ms and 1.8 ms, respectively.

FIGS. 20A and 20B are simulation results depicting a 99th percentile additional burst packet delay (meaning 99% of packets experience delays less than shown) resulting from measurement gaps with respect to the necessary duration PDSCH transmission period for burst traffic, assuming a measurement gap length (MGL) of 6 ms, without and with enhanced measurement gaps, respectively.

As illustrated in FIG. 20A, without enhanced measurement gaps, PDB requirements may rarely be met when the required active time is greater than 4 ms, due to significant additional packet burst packet delay resulting from measurement gaps. For example, for a single-UE scenario, the 99th percentile additional burst packet delay may be 33 ms for 30 Hz traffic (2002) and 17 ms for 60 Hz traffic (2004). For a multi-UE scenario, the 99th percentile additional burst packet delay may be 35 ms for 30 Hz traffic and 17 ms for 60 Hz traffic.

As illustrated in FIG. 20B, enhanced measurement gaps may significantly decrease the additional packet burst packet delay resulting from measurement gaps. For example, for a single-UE scenario, the 99th percentile additional burst packet delay may be 8 ms for 30 Hz traffic (2002) and 8 ms for 60 Hz traffic (2004). For a multi-UE scenario, the 99th percentile additional burst packet delay may also be 8 ms for 30 Hz traffic and 8 ms for 60 Hz traffic, thus allowing PDB requirements to be met more often.

FIGS. 20C and 20D are simulation results depicting 99th percentile additional burst packet delay resulting from measurement gaps with respect to the necessary duration PDSCH transmission period for burst traffic, assuming a measurement gap length (MGL) of 3 ms, without and with enhanced measurement gaps, respectively. As illustrated, enhanced measurement gaps may bring the 99th percentile additional packet burst delay down. For example, for a single-UE scenario, the 99th percentile additional burst packet delay may be lowered from 34 ms for 30 Hz traffic (2002) and 5 ms for 60 Hz traffic (2004) to 5 ms and 5 ms, respectively. For a multi-UE scenario, the average additional burst packet delay may be lowered from 35 ms for 30 Hz traffic and 17 ms for 60 Hz traffic to 5 ms and 5 ms, respectively.

### Example Operations

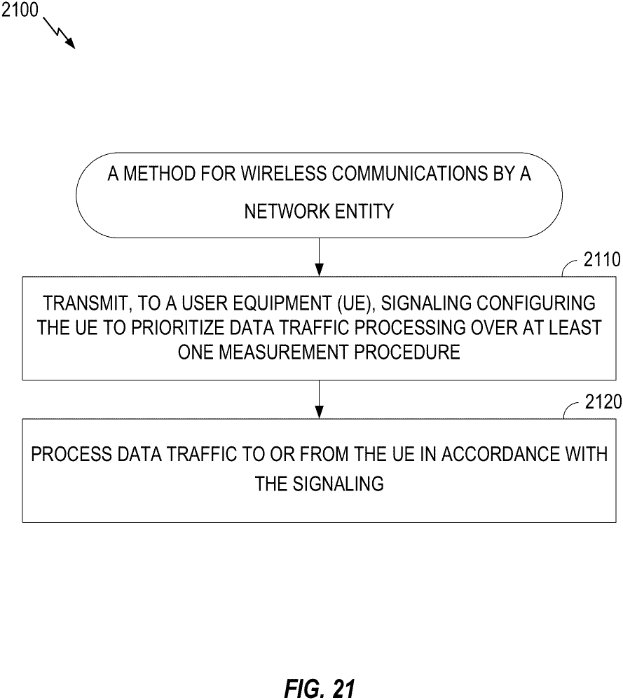

FIG. 21 illustrates example operations 2100 for wireless communication by a network entity. The operations 2100 may be performed, for example, by a base station (e.g., BS 102 of FIG. 1) to configure a UE for enhanced measurement gaps.

At 2110, the network entity transmits, to a user equipment (UE), signaling configuring the UE to prioritize data traffic processing over at least one measurement procedure.

At 2120, the network entity processes data traffic to or from the UE in accordance with the signaling.

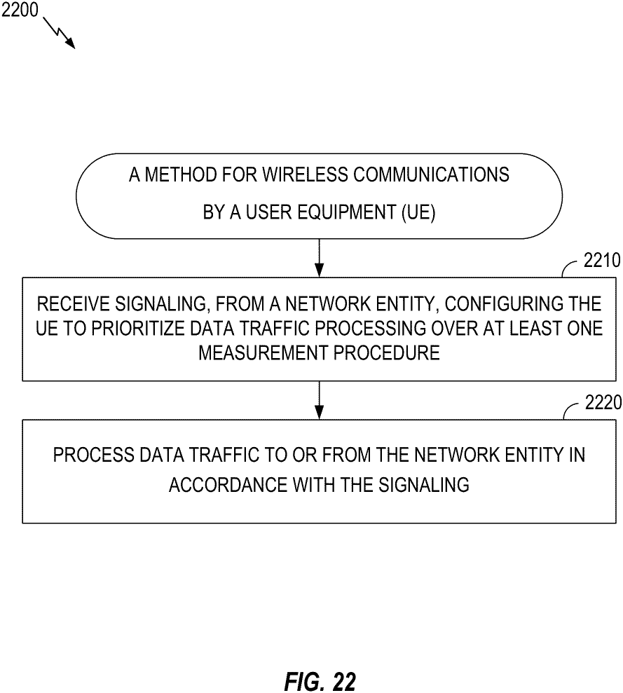

FIG. 22 illustrates example operations 2200 for wireless communication by a UE. The operations 2200 may be performed, for example, by a UE (e.g., such as a UE 104 of FIG. 1) to perform an enhanced measurement gap procedure.

At 2210, the UE receives signaling, from a network entity, configuring the UE to prioritize data traffic processing over at least one measurement procedure.

At 2220, the UE processes data traffic to or from the network entity in accordance with the signaling.

### Example Wireless Communication Devices

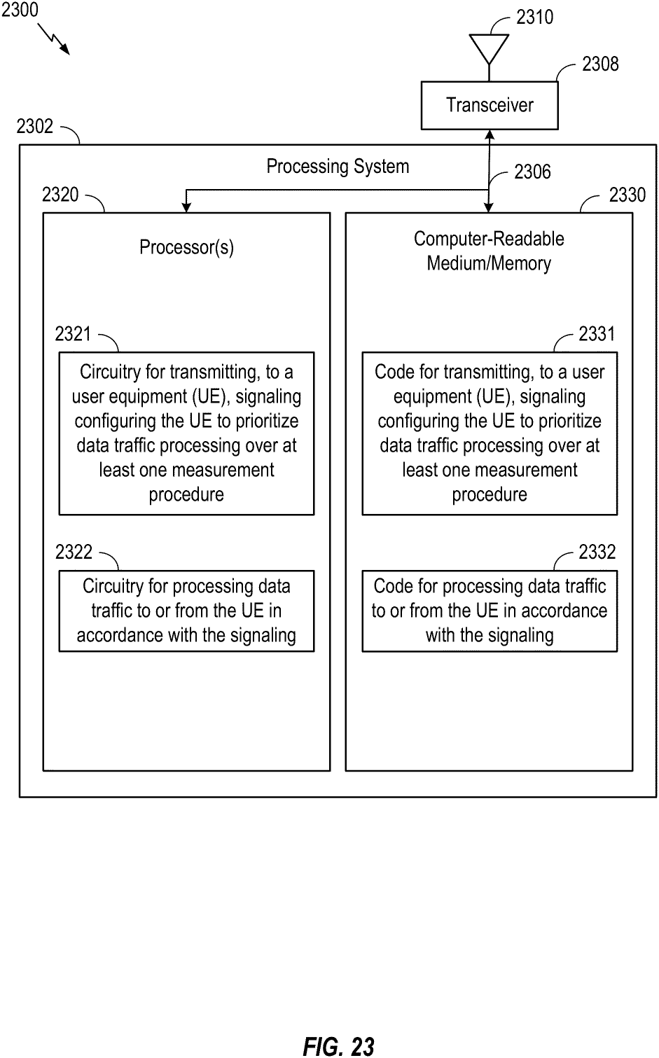

FIG. 23 depicts an example communications device 2300 that includes various components operable, configured, or adapted to perform operations for the techniques disclosed herein, such as the operations depicted and described with respect to FIG. 21. In some examples, communication device 2300 may be a base station 102 as described, for example with respect to FIGS. 1 and 2.

Communications device 2300 includes a processing system 2302 coupled to a transceiver 2308 (e.g., a transmitter and/or a receiver). Transceiver 2308 is configured to transmit (or send) and receive signals for the communications device 2300 via an antenna 2310, such as the various signals as described herein. Processing system 2302 may be configured to perform processing functions for communications device 2300, including processing signals received and/or to be transmitted by communications device 2300.

Processing system 2302 includes one or more processors 2320 coupled to a computer-readable medium/memory 2330 via a bus 2306. In certain aspects, computer-readable medium/memory 2330 is configured to store instructions (e.g., computer-executable code) that when executed by the one or more processors 2320, cause the one or more processors 2320 to perform the operations illustrated in FIG. 21, or other operations for performing the various techniques discussed herein.

In the depicted example, computer-readable medium/memory 2330 stores code 2331 for transmitting, to a user equipment (UE), signaling configuring the UE to prioritize data traffic processing over at least one measurement procedure and code 2332 for processing data traffic to or from the UE in accordance with the signaling.

In the depicted example, the one or more processors 2320 include circuitry configured to implement the code stored in the computer-readable medium/memory 2330, including circuitry 2321 for transmitting, to a user equipment (UE), signaling configuring the UE to prioritize data traffic processing over at least one measurement procedure and circuitry 2322 for processing data traffic to or from the UE in accordance with the signaling.

Various components of communications device 2300 may provide means for performing the methods described herein, including with respect to FIG. 21.

In some examples, means for transmitting or sending (or means for outputting for transmission) may include the transceivers 232 and/or antenna(s) 234 of the base station 102 illustrated in FIG. 2 and/or transceiver 2308 and antenna 2310 of the communication device 2300 in FIG. 23.

In some examples, means for receiving (or means for obtaining) may include the transceivers 232 and/or antenna(s) 234 of the base station illustrated in FIG. 2 and/or transceiver 2308 and antenna 2310 of the communication device 2300 in FIG. 23.

In some examples, means for receiving and/or controlling may include various processing system components, such as: the one or more processors 2320 in FIG. 23, or aspects of the base station 102 depicted in FIG. 2, including receive processor 238, transmit processor 220, TX MIMO processor 230, and/or controller/processor 240 (including FD capability component 241).

Notably, FIG. 23 is an example, and many other examples and configurations of communication device 2300 are possible.

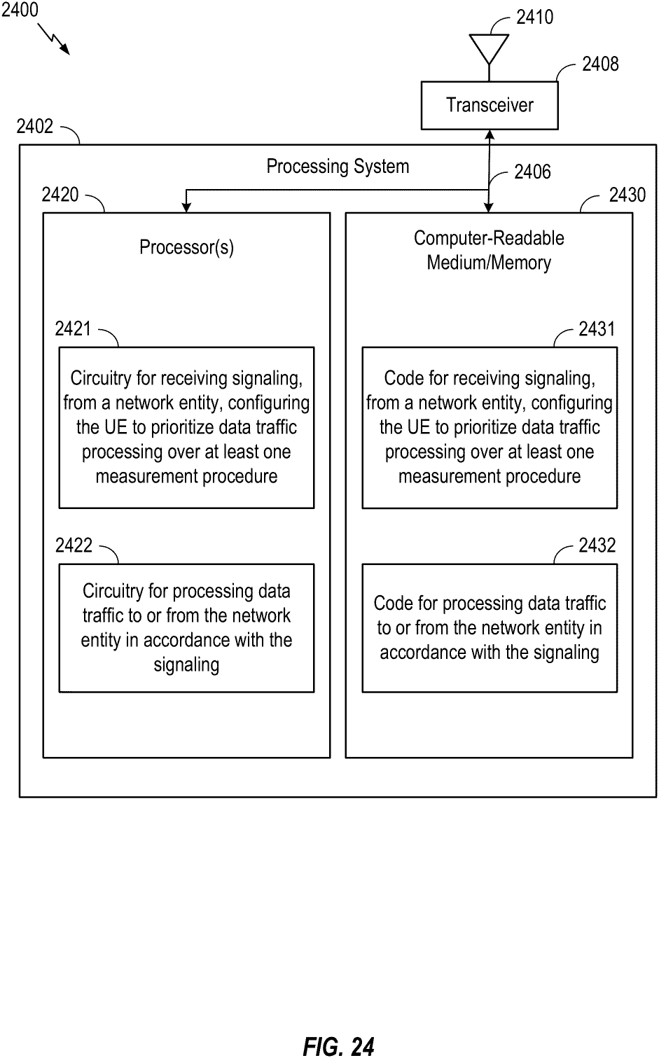

FIG. 24 depicts an example communications device 2400 that includes various components operable, configured, or adapted to perform operations for the techniques disclosed herein, such as the operations depicted and described with respect to FIG. 22. In some examples, communication device 2400 may be a user equipment 104 as described, for example with respect to FIGS. 1 and 2.

Communications device 2400 includes a processing system 2402 coupled to a transceiver 2408 (e.g., a transmitter and/or a receiver). Transceiver 2408 is configured to transmit (or send) and receive signals for the communications device 2400 via an antenna 2410, such as the various signals as described herein. Processing system 2402 may be configured to perform processing functions for communications device 2400, including processing signals received and/or to be transmitted by communications device 2400.

Processing system 2402 includes one or more processors 2420 coupled to a computer-readable medium/memory 2430 via a bus 2406. In certain aspects, computer-readable medium/memory 2430 is configured to store instructions (e.g., computer-executable code) that when executed by the one or more processors 2420, cause the one or more processors 2420 to perform the operations illustrated in FIG. 22, or other operations for performing the various techniques discussed herein.

In the depicted example, computer-readable medium/memory 2430 stores code 2431 for receiving signaling, from a network entity, configuring the UE to prioritize data traffic processing over at least one measurement procedure and code 2432 for processing data traffic to or from the network entity in accordance with the signaling.

In the depicted example, the one or more processors 2420 include circuitry configured to implement the code stored in the computer-readable medium/memory 2430, including circuitry 2421 for receiving signaling, from a network entity, configuring the UE to prioritize data traffic processing over at least one measurement procedure and circuitry 2422 for processing data traffic to or from the network entity in accordance with the signaling.

Various components of communications device 2400 may provide means for performing the methods described herein, including with respect to FIG. 22.

In some examples, means for transmitting or sending (or means for outputting for transmission) may include the transceivers 254 and/or antenna(s) 252 of the user equipment 104 illustrated in FIG. 2 and/or transceiver 2408 and antenna 2410 of the communication device 2400 in FIG. 24.

In some examples, means for receiving (or means for obtaining) may include the transceivers 254 and/or antenna(s) 252 of the user equipment 104 illustrated in FIG. 2 and/or transceiver 2408 and antenna 2410 of the communication device 2400 in FIG. 24.

In some examples, means for generating and/or transmitting may include various processing system components, such as: the one or more processors 2420 in FIG. 24, or aspects of the user equipment 104 depicted in FIG. 2, including receive processor 258, transmit processor 264, TX MIMO processor 266, and/or controller/processor 280 (including FD capability component 281).

Notably, FIG. 24 is an example, and many other examples and configurations of communication device 2400 are possible.

### Example Clauses

Implementation examples are described in the following numbered clauses:

Clause 1: A method for wireless communications by a user equipment (UE), comprising receiving signaling, from a network entity, configuring the UE to prioritize data traffic processing over at least one measurement procedure, and processing data traffic to or from the network entity in accordance with the signaling.

Clause 2: The method of clause 1, wherein the signaling comprises a radio resource control (RRC) information element (IE) to configure the priority between the data traffic processing and performing the measurement procedure during configured measurement gaps.

Clause 3: The method of clause 2, wherein the RRC IE indicates the UE is to prioritize the data traffic processing over performing the measurement procedure during the configured measurement gaps within connected discontinuous reception (CDRX) active cycles.

Clause 4: The method of clause 3, wherein the UE is configured to perform the measurement procedure during measurement gaps that fit within CDRX inactive cycles.

Clause 5: The method of clause 4, further comprising determining whether a measurement gap fits within one of the CDRX inactive cycles based on a subsequent CDRX active cycle, when entering a CDRX inactive state.

Clause 6: The method of any one of clauses 3 through 5, further comprising assuming a previous measurement result, when the UE skips performing the measurement procedure in a measurement gap that overlaps with a CDRX active cycle.

Clause 7: The method of any one of clauses 1 through 6, wherein the signaling configuring the UE to prioritize the data traffic processing over the measurement procedure is based on a quality of service (QoS) Identifier (QI) value.

Clause 8: The method of any one of clauses 1 through 7, wherein the UE is configured to override the priority configured by the signaling to perform one or more certain procedures considered higher priority.

Clause 9: The method of any one of clauses 1 through 8, further comprising receiving additional signaling reconfiguring the UE to prioritize a measurement gap procedure over the data traffic processing.

Clause 10: The method of clause 9, wherein the additional signaling comprises at least one of downlink control information (DCI) or medium access control (MAC) control element (CE) signaling.

Clause 11: The method of clause 10, further comprising determining whether a measurement gap fits within one of the CDRX inactive cycles based on a subsequent CDRX active cycle, when entering a CDRX inactive state.

Clause 12: The method of any one of clauses 10 through 11, wherein the DCI or MAC CE comprises a command for the UE to enter a connected discontinuous reception (CDRX) inactive state before a subsequent measurement gap.

Clause 13: The method of any one of clauses 1 through 12, wherein the signaling comprises downlink control information (DCI) with a cyclic redundancy check (CRC) scrambled with a power saving radio network temporary identifier (PS-RNTI) or another radio network temporary identifier (RNTI) indicating a bitmap that activates or inactivates one or more subsequent measurement gaps.

Clause 14: The method of any one of clauses 1 through 13, wherein processing the data traffic in accordance with the signaling comprises performing cell measurement in a measurement gap that occurs while the UE is in a connected discontinuous reception (CDRX) active state, and taking one or more actions to resume the CDRX active state after the measurement gap.

Clause 15: The method of clause 14, wherein the one or more actions comprise pausing at least one of a CDRX on duration timer, a CDRX inactivity timer, or a CDRX retransmission timer during the measurement gap.

Clause 16: The method of any one of clauses 14 through 15, wherein the one or more actions comprise starting a timer at a beginning of the measurement gap, resuming the CDRX active state after the measurement gap, and remaining in the CDRX active state until expiration of the timer.

Clause 17: The method of any one of clauses 1 through 16, wherein processing the data traffic in accordance with the signaling comprises transmitting a scheduling request (SR) to the network entity to transition from an inactive state to an active state and receive data traffic, if the UE enters the inactive state during a measurement gap.

Clause 18: The method of any one of clauses 1 through 17, wherein the signaling comprises at least one of downlink control information (DCI) or medium access control (MAC) control element (CE) signaling that dynamically adjusts a connected discontinuous reception (CDRX) start offset according to measurement gaps.

Clause 19: The method of any one of clauses 1 through 18, wherein the signaling comprises signaling that adjusts at least one of periodic measurement gaps, semi-persistent measurement gaps, or aperiodic measurement gaps.

Clause 20: The method of clause 19, wherein the signaling comprises a medium access control (MAC) control element (CE) that semi-persistently activates or deactivates measurement gaps or a downlink control information (DCI) that semi-persistently activates or deactivates measurement gaps.

Clause 21: The method of any one of clauses 19 through 20, wherein the signaling comprises at least one of downlink control information (DCI) or medium access control (MAC) control element (CE) that aperiodically indicates timing of measurement gaps.

Clause 22: The method of clause 21, wherein the DCI triggers a subsequent measurement procedure in a measurement gap configured via radio resource control (RRC) signaling.

Clause 23: The method of any one of clauses 21 through 22, wherein the MAC-CE includes at least one of a system frame number (SFN), subframe, slot, or measurement gap length of a subsequent measurement gap, and triggers the UE to perform the measurement procedure in the subsequent measurement gap.

Clause 24: The method of any one of clauses 1 through 23, wherein the measurement procedure comprises a cross link interference (CLI) measurement procedure.

Clause 25: A method for wireless communications by a network entity, comprising transmitting, to a user equipment (UE), signaling configuring the UE to prioritize data traffic processing over at least one measurement procedure, and processing data traffic to or from the UE in accordance with the signaling.

Clause 26: The method of clause 25, wherein the signaling comprises a radio resource control (RRC) information element (IE) to configure the priority between the data traffic processing and performing the measurement procedure during configured measurement gaps.

Clause 27: The method of clause 26, wherein the RRC IE indicates the UE is to prioritize the data traffic processing over performing the measurement procedure during the configured measurement gaps within connected discontinuous reception (CDRX) active cycles.

Clause 28: The method of clause 27, wherein the signaling configures the UE to perform the measurement procedure during measurement gaps that fit within CDRX inactive cycles.

Clause 29: The method of clause 28, further comprising determining whether a measurement gap fits within one of the CDRX inactive cycles based on a subsequent CDRX active cycle, when entering a CDRX inactive state.

Clause 30: The method of any one of clauses 27 through 29, further comprising assuming a previous measurement result, when the UE skips performing the measurement procedure in a measurement gap that overlaps with a CDRX active cycle.

Clause 31: The method of any one of clauses 25 through 30, wherein the signaling configuring the UE to prioritize the data traffic processing over the measurement procedure is based on a quality of service (QoS) Identifier (QI) value.

Clause 32: The method of any one of clauses 25 through 31, further comprising transmitting additional signaling reconfiguring the UE to prioritize a measurement gap procedure over the data traffic processing.

Clause 33: The method of clause 32, wherein the additional signaling comprises at least one of downlink control information (DCI) or medium access control (MAC) control element (CE) signaling.

Clause 34: The method of clause 33, further comprising determining whether a measurement gap fits within one of the CDRX inactive cycles based on a subsequent CDRX active cycle, when entering a CDRX inactive state.

Clause 35: The method of any one of clauses 33 through 34, wherein the DCI or MAC CE comprises a command for the UE to enter a connected discontinuous reception (CDRX) inactive state before a subsequent measurement gap.

Clause 36: The method of any one of clauses 25 through 35, wherein the signaling comprises downlink control information (DCI) with a cyclic redundancy check (CRC) scrambled with a power saving radio network temporary identifier (PS-RNTI) or another radio network temporary identifier (RNTI) indicating a bitmap that activates or inactivates one or more subsequent measurement gaps.

Clause 37: The method of any one of clauses 25 through 36, wherein processing the data traffic in accordance with the signaling comprises receiving, from the UE, a scheduling request (SR) to transition the UE from an inactive state to an active state and receive data traffic, if the UE enters the inactive state during a measurement gap.

Clause 38: The method of any one of clauses 25 through 37, wherein the signaling comprises at least one of downlink control information (DCI) or medium access control (MAC) control element (CE) signaling that dynamically adjusts a connected discontinuous reception (CDRX) start offset according to measurement gaps.

Clause 39: The method of any one of clauses 25 through 38, wherein the signaling comprises signaling that adjusts at least one of periodic measurement gaps, semi-persistent measurement gaps, or aperiodic measurement gaps.

Clause 40: The method of clause 39, wherein the signaling comprises a medium access control (MAC) control element (CE) that semi-persistently activates or deactivates measurement gaps or a downlink control information (DCI) that semi-persistently activates or deactivates measurement gaps.

Clause 41: The method of any one of clauses 39 through 40, wherein the signaling comprises at least one of downlink control information (DCI) or medium access control (MAC) control element (CE) that aperiodically indicates timing of measurement gaps.

Clause 42: The method of clause 41, wherein the DCI triggers a subsequent measurement procedure in a measurement gap configured via radio resource control (RRC) signaling.

Clause 43: The method of any one of clauses 41 through 42, wherein the MAC-CE includes at least one of a system frame number (SFN), subframe, slot, or measurement gap length of a subsequent measurement gap, and triggers the UE to perform the measurement procedure in the subsequent measurement gap.

Clause 44: The method of any one of clauses 25 through 43, wherein the measurement procedure comprises a cross link interference (CLI) measurement procedure.

Clause 45: An apparatus, comprising: a memory comprising executable instructions; one or more processors configured to execute the executable instructions and cause the apparatus to perform a method in accordance with any one of Clauses 1-44.

Clause 46: An apparatus, comprising means for performing a method in accordance with any one of Clauses 1-44.

Clause 47: A non-transitory computer-readable medium comprising executable instructions that, when executed by one or more processors of an apparatus, cause the apparatus to perform a method in accordance with any one of Clauses 1-44.

Clause 48: A computer program product embodied on a computer-readable storage medium comprising code for performing a method in accordance with any one of Clauses 1-44.

### Additional Wireless Communication Network Considerations

The techniques and methods described herein may be used for various wireless communications networks (or wireless wide area network (WWAN)) and radio access technologies (RATs). While aspects may be described herein using terminology commonly associated with 3G, 4G, and/or 5G (e.g., 5G new radio (NR)) wireless technologies, aspects of the present disclosure may likewise be applicable to other communication systems and standards not explicitly mentioned herein.

5G wireless communication networks may support various advanced wireless communication services, such as enhanced mobile broadband (eMBB), millimeter wave (mmWave), machine type communications (MTC), and/or mission critical targeting ultra-reliable, low-latency communications (URLLC). These services, and others, may include latency and reliability requirements.

Returning to FIG. 1, various aspects of the present disclosure may be performed within the example wireless communication network 100.

In 3GPP, the term “cell” can refer to a coverage area of a NodeB and/or a narrowband subsystem serving this coverage area, depending on the context in which the term is used. In NR systems, the term “cell” and BS, next generation NodeB (gNB or gNodeB), access point (AP), distributed unit (DU), carrier, or transmission reception point may be used interchangeably. A BS may provide communication coverage for a macro cell, a pico cell, a femto cell, and/or other types of cells.

A macro cell may generally cover a relatively large geographic area (e.g., several kilometers in radius) and may allow unrestricted access by UEs with service subscription. A pico cell may cover a relatively small geographic area (e.g., a sports stadium) and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG) and UEs for users in the home). A BS for a macro cell may be referred to as a macro BS. A BS for a pico cell may be referred to as a pico BS. A BS for a femto cell may be referred to as a femto BS, home BS, or a home NodeB.

Base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). Base stations 102 configured for 5G (e.g., 5G NR or Next Generation RAN (NG-RAN)) may interface with 5GC 190 through second backhaul links 184. Base stations 102 may communicate directly or indirectly (e.g., through the EPC 160 or 5GC 190) with each other over third backhaul links 134 (e.g., X2 interface). Third backhaul links 134 may generally be wired or wireless.

Small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. Small cell 102′, employing NR in an unlicensed frequency spectrum, may boost coverage to and/or increase capacity of the access network.

Some base stations, such as gNB 180 may operate in a traditional sub-6 GHz spectrum, in millimeter wave (mmWave) frequencies, and/or near mmWave frequencies in communication with the UE 104. When the gNB 180 operates in mmWave or near mmWave frequencies, the gNB 180 may be referred to as an mmWave base station.

The communication links 120 between base stations 102 and, for example, UEs 104, may be through one or more carriers. For example, base stations 102 and UEs 104 may use spectrum up to Y MHz (e.g., 5, 10, 15, 20, 100, 400, and other MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Wireless communications system 100 further includes a Wi-Fi access point (AP) 150 in communication with Wi-Fi stations (STAs) 152 via communication links 154 in, for example, a 2.4 GHz and/or 5 GHz unlicensed frequency spectrum. When communicating in an unlicensed frequency spectrum, the STAs 152 / AP 150 may perform a clear channel assessment (CCA) prior to communicating in order to determine whether the channel is available.

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, 4G (e.g., LTE), or 5G (e.g., NR), to name a few options.

EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to the IP Services 176, which may include, for example, the Internet, an intranet, an IP Multimedia Subsystem (IMS), a PS Streaming Service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

5GC 190 may include an Access and Mobility Management Function (AMF) 192, other AMFs 193, a Session Management Function (SMF) 194, and a User Plane Function (UPF) 195. AMF 192 may be in communication with a Unified Data Management (UDM) 196.

AMF 192 is generally the control node that processes the signaling between UEs 104 and 5GC 190. Generally, AMF 192 provides QoS flow and session management.

All user Internet protocol (IP) packets are transferred through UPF 195, which is connected to the IP Services 197, and which provides UE IP address allocation as well as other functions for 5GC 190. IP Services 197 may include, for example, the Internet, an intranet, an IP Multimedia Subsystem (IMS), a PS Streaming Service, and/or other IP services.

Returning to FIG. 2, various example components of BS 102 and UE 104 (e.g., the wireless communication network 100 of FIG. 1) are depicted, which may be used to implement aspects of the present disclosure.

At BS 102, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), and others. The data may be for the physical downlink shared channel (PDSCH), in some examples.

A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

Processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At UE 104, antennas 252a-252r may receive the downlink signals from the BS 102 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM) to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 104 to a data sink 260, and provide decoded control information to a controller/processor 280.

On the uplink, at UE 104, transmit processor 264 may receive and process data (e.g., for the physical uplink shared channel (PUSCH)) from a data source 262 and control information (e.g., for the physical uplink control channel (PUCCH) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 102.

At BS 102, the uplink signals from UE 104 may be received by antennas 234at, processed by the demodulators in transceivers 232a-232t, detected by a MIMO detector 236 if applicable, and further processed by a receive processor 238 to obtain decoded data and control information sent by UE 104. Receive processor 238 may provide the decoded data to a data sink 239 and the decoded control information to the controller/processor 240.

Memories 242 and 282 may store data and program codes for BS 102 and UE 104, respectively.

Scheduler 244 may schedule UEs for data transmission on the downlink and/or uplink.

5G may utilize orthogonal frequency division multiplexing (OFDM) with a cyclic prefix (CP) on the uplink and downlink. 5G may also support half-duplex operation using time division duplexing (TDD). OFDM and single-carrier frequency division multiplexing (SC-FDM) partition the system bandwidth into multiple orthogonal subcarriers, which are also commonly referred to as tones and bins. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers in some examples. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, and others).

As above, FIGS. 3A-3D depict various example aspects of data structures for a wireless communication network, such as wireless communication network 100 of FIG. 1.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 3A and 3C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (µ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology µ, there are 14 symbols/slot and 2µ slots/subframe. The subcarrier spacing and symbol length/duration are a function of the numerology. The subcarrier spacing may be equal to 2^{µ} x 15 kHz, where 15 is the numerology 0 to 5. As such, the numerology µ = 0 has a subcarrier spacing of 15 kHz and the numerology µ = 5 has a subcarrier spacing of 480 kHz. The symbol length/duration is inversely related to the subcarrier spacing. FIGS. 3A-3D provide an example of slot configuration 0 with 14 symbols per slot and numerology µ = 2 with 4 slots per subframe. The slot duration is 0.25 ms, the subcarrier spacing is 60 kHz, and the symbol duration is approximately 16.67 µs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for a UE (e.g., UE 104 of FIGS. 1 and 2). The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Additional Considerations

The preceding description provides examples of enhanced measurement gap procedures prioritizing data traffic in communication systems. The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The techniques described herein may be used for various wireless communication technologies, such as 5G (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, and others. UTRA includes Wideband CDMA (WCDMA) and other variants of CDMA. cdma2000 covers IS-2000, IS-95, and IS-856 standards. A TDMA network may implement a radio technology such as Global System for Mobile Communications (GSM). An OFDMA network may implement a radio technology such as NR (e.g., 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, and others. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user equipment (see FIG. 1), a user interface (e.g., keypad, display, mouse, joystick, touchscreen, biometric sensor, proximity sensor, light emitting element, and others) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. §112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for wireless communications by a user equipment (UE), comprising:
receiving signaling, from a network entity, configuring the UE to prioritize data traffic processing over at least one measurement procedure; and
processing data traffic to or from the network entity in accordance with the signaling.

2. The method of claim 1, wherein the signaling comprises a radio resource control (RRC) information element (IE) to configure a priority between the data traffic processing and performing the measurement procedure during configured measurement gaps, and wherein the RRC IE indicates the UE is to prioritize the data traffic processing over performing the measurement procedure during the configured measurement gaps within connected discontinuous reception (CDRX) active cycles.

3. The method of claim 2, wherein the UE is configured to perform the measurement procedure during measurement gaps that fit within CDRX inactive cycles, and the method further comprises:
determining whether a measurement gap fits within one of the CDRX inactive cycles based on a subsequent CDRX active cycle, when entering a CDRX inactive state.

4. The method of claim 2, further comprising:
assuming a previous measurement result, when the UE skips performing the measurement procedure in a measurement gap that overlaps with a CDRX active cycle.

5. The method of claim 1, wherein either:
the signaling configuring the UE to prioritize the data traffic processing over a measurement gap procedure is based on a quality of service (QoS) Identifier (QI) value;
the UE is configured to override a priority configured by the signaling to perform one or more certain procedures considered higher priority; or
the signaling comprises downlink control information (DCI) with a cyclic redundancy check (CRC) scrambled with a power saving radio network temporary identifier (PS-RNTI) or another radio network temporary identifier (RNTI) indicating a bitmap that activates or inactivates one or more subsequent measurement gaps.

6. The method of claim 1, further comprising receiving additional signaling reconfiguring the UE to prioritize a measurement gap procedure over the data traffic processing, wherein the additional signaling comprises at least one of downlink control information (DCI) or medium access control (MAC) control element (CE) signaling.

7. The method of claim 6, further comprising:
determining whether a measurement gap fits within a connected discontinuous reception (CDRX) inactive cycle based on a subsequent CDRX active cycle, when entering a CDRX inactive state.

8. The method of claim 6, wherein:
the DCI or MAC CE comprises a command for the UE to enter a connected discontinuous reception (CDRX) inactive state before a subsequent measurement gap; and
when the additional signaling comprises the DCI, a cyclic redundancy check (CRC) of the DCI is scrambled with a power saving radio network temporary identifier (PS-RNTI) or another radio network temporary identifier (RNTI) indicating a bitmap that activates or inactivates one or more subsequent measurement gaps.

9. The method of claim 1, wherein processing the data traffic in accordance with the signaling comprises:
performing cell measurement in a measurement gap that occurs while the UE is in a connected discontinuous reception (CDRX) active state; and
taking one or more actions to resume the CDRX active state after the measurement gap, wherein the one or more actions comprise at least one of:
pausing at least one of a CDRX on duration timer, a CDRX inactivity timer, or a CDRX retransmission timer during the measurement gap; or
a combination of:
starting a timer at a beginning of the measurement gap;
resuming the CDRX active state after the measurement gap; and
remaining in the CDRX active state until expiration of the timer.

10. The method of claim 1, wherein processing the data traffic in accordance with the signaling comprises:
transmitting a scheduling request (SR) to the network entity to transition from an inactive state to an active state and receive data traffic, if the UE enters the inactive state during a measurement gap, wherein the signaling comprises at least one of downlink control information (DCI) or medium access control (MAC) control element (CE) signaling that dynamically adjusts a connected discontinuous reception (CDRX) start offset according to measurement gaps.

11. The method of claim 1, wherein the signaling comprises signaling that adjusts at least one of periodic measurement gaps, semi-persistent measurement gaps, or aperiodic measurement gaps.

12. The method of claim 11, wherein the signaling comprises a medium access control (MAC) control element (CE) that semi-persistently activates or deactivates measurement gaps or a downlink control information (DCI) that semi-persistently activates or deactivates the measurement gaps.

13. The method of claim 11, wherein:
the signaling comprises at least one of a downlink control information (DCI) or a medium access control (MAC) control element (CE) that aperiodically indicates timing of measurement gaps;
when the signaling comprises the DCI, the DCI triggers a subsequent measurement procedure in a measurement gap configured via radio resource control (RRC) signaling; and
when the signaling comprises the MAC-CE, the MAC-CE includes at least one of a system frame number (SFN), subframe, slot, or measurement gap length of a subsequent measurement gap, and triggers the UE to perform the measurement procedure in the subsequent measurement gap.

14. The method of claim 1, wherein the measurement procedure comprises a cross link interference (CLI) measurement procedure.

15. A method for wireless communications by a network entity, comprising:
transmitting, to a user equipment (UE), signaling configuring the UE to prioritize data traffic processing over at least one measurement procedure; and
processing data traffic to or from the UE in accordance with the signaling.

16. The method of claim 15, wherein the signaling comprises a radio resource control (RRC) information element (IE) to configure a priority between the data traffic processing and performing the measurement procedure during configured measurement gaps and wherein the RRC IE indicates the UE is to prioritize the data traffic processing over performing the measurement procedure during the configured measurement gaps within connected discontinuous reception (CDRX) active cycles.

17. The method of claim 16, wherein the signaling configures the UE to perform the measurement procedure during measurement gaps that fit within CDRX inactive cycles, and the method further comprises:
determining whether a measurement gap fits within one of the CDRX inactive cycles based on a subsequent CDRX active cycle.

18. The method of claim 16, further comprising:
assuming a previous measurement result, when the UE skips performing the measurement procedure in a measurement gap that overlaps with a CDRX active cycle.

19. The method of claim 15, wherein:
the signaling configuring the UE to prioritize the data traffic processing over the measurement procedure is based on a quality of service (QoS) Identifier (QI) value; or
the signaling comprises downlink control information (DCI) with a cyclic redundancy check (CRC) scrambled with a power saving radio network temporary identifier (PS-RNTI) or another radio network temporary identifier (RNTI) indicating a bitmap that activates or inactivates one or more subsequent measurement gaps.

20. The method of claim 15, further comprising transmitting additional signaling reconfiguring the UE to prioritize a measurement gap procedure over the data traffic processing, wherein the additional signaling comprises at least one of downlink control information (DCI) or medium access control (MAC) control element (CE) signaling.

21. The method of claim 20, further comprising:
determining whether a measurement gap fits within a connected discontinuous reception (CDRX) inactive cycle based on a subsequent CDRX active cycle.

22. The method of claim 20, wherein the DCI or MAC CE comprises a command for the UE to enter a connected discontinuous reception (CDRX) inactive state before a subsequent measurement gap.

23. The method of claim 15, wherein processing the data traffic in accordance with the signaling comprises:
receiving, from the UE, a scheduling request (SR) to transition the UE from an inactive state to an active state and receive data traffic, if the UE enters the inactive state during a measurement gap.

24. The method of claim 15, wherein the signaling comprises at least one of downlink control information (DCI) or medium access control (MAC) control element (CE) signaling that dynamically adjusts a connected discontinuous reception (CDRX) start offset according to measurement gaps.

25. The method of claim 15, wherein the signaling comprises signaling that adjusts at least one of periodic measurement gaps, semi-persistent measurement gaps, or aperiodic measurement gaps.

26. The method of claim 25, wherein the signaling comprises a medium access control (MAC) control element (CE) that semi-persistently activates or deactivates measurement gaps or a downlink control information (DCI) that semi-persistently activates or deactivates the measurement gaps.

27. The method of claim 25, wherein:
the signaling comprises at least one of a downlink control information (DCI) or a medium access control (MAC) control element (CE) that aperiodically indicates timing of measurement gaps;
when the signaling comprises the DCI, the DCI triggers a subsequent measurement procedure in a measurement gap configured via radio resource control (RRC) signaling; and
when the signaling comprises the MAC-CE, the MAC-CE includes at least one of a system frame number (SFN), subframe, slot, or measurement gap length of a subsequent measurement gap, and triggers the UE to perform the measurement procedure in the subsequent measurement gap.

28. The method of claim 15, wherein the measurement procedure comprises a cross link interference (CLI) measurement procedure.

29. An apparatus, comprising:
a memory comprising executable instructions; and
one or more processors configured to execute the executable instructions and cause the apparatus to:
receive signaling, from a network entity, configuring a user equipment (UE) to prioritize data traffic processing over at least one measurement procedure; and
process data traffic to or from the network entity in accordance with the signaling.

30. An apparatus, comprising:
a memory comprising executable instructions; and
one or more processors configured to execute the executable instructions and cause the apparatus to:
transmit, to a user equipment (UE), signaling configuring the UE to prioritize data traffic processing over at least one measurement procedure; and
process data traffic to or from the UE in accordance with the signaling.
